(19) United States
(12) Patent Application Publication
(10) Pub. No.: US 2026/0087368 A1
(43) Pub. Date: Mar. 26, 2026

(54) FINE-TUNING LANGUAGE MODELS FOR REASONING WITH COUNTERFACTUAL FEEDBACK

(71) Applicant: Microsoft Technology Licensing, LLC, Redmond, WA (US)

(72) Inventors: Javier GONZÁLEZ HERNÁNDEZ, Cambridge (GB); Aditya Vithal NORI, Cambridge (GB); Xinnuo XU, Beijing (CN); Jacqueline MAASCH, New York, NY (US); Alihan HÜYÜK, Cambridge, MA (US)

(21) Appl. No.: 19/075,729

(22) Filed: Mar. 10, 2025

Related U.S. Application Data
(60) Provisional application No. 63/699,777, filed on Sep. 26, 2024.

(51) Int. Cl. G06N 3/096; G06F 21/55; G06F 40/40

(52) U.S. Cl. CPC G06N 3/096; G06F 21/554; G06F 40/40; G06F 2221/033

(57) ABSTRACT

Example solutions for fine-tuning a language model include: generating a dataset that includes a plurality of paired samples, each paired sample of the plurality of paired samples includes (i) a factual question and a true outcome for that factual question and (ii) a counterfactual question and a true outcome for that counterfactual question; submitting a factual query to an answer model, the factual query including the factual question and the true outcome of the factual question, the answer model generating a factual answer in response to the factual query; submitting a counterfactual query to the answer model, the counterfactual query including the counterfactual question and the true outcome of the counterfactual question, the answer model generating a counterfactual answer in response to the counterfactual query; and performing fine-tuning on a target model using at least the factual question paired with factual answer and the counterfactual question paired with counterfactual answer.

This application claims priority to U.S. Provisional Patent Application No. 63/699,777, entitled “FINE-TUNING LANGUAGE MODELS FOR REASONING WITH COUNTERFACTUAL FEEDBACK,” filed on Sep. 26, 2024, the disclosure of which is incorporated herein by reference in its entirety.

### BACKGROUND

Generative artificial intelligence (GAI) models, such as language models (LMs), have revolutionized the way people interact with technology, enabling more natural and intuitive communication between humans and computers in applications like writing assistants, sentiment analysis in social media, healthcare, and many others. Despite the surge of interest and recent breakthroughs, the ability of LMs to reason about real-world problems continues to be a topic of intense research.

GAI models (e.g., large language models (LLMs)) are shown to be capable of delivering astounding performance in numerous tasks across various domains. Examples include writing assistants, sentiment analysis in social media, and applications in healthcare. While ever increasing accuracy of these models is significant, it remains unclear as to what extent this accuracy is due to effective recall of training data versus a genuine ability of the models to perform computational reasoning by extracting, understanding, and adapting the fundamental concepts underlying that training data. Some prior work suggests that LMs exhibit some emergent capability of reasoning, but this capability has also found to have a significant reasoning-recall gap, where models perform substantially better on recall-based tasks that do not explicitly rely on reasoning.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Aspects of the disclosure provide improved results in technical applications, such as in cybersecurity (e.g., where a fine-tuned model is used in a security system to reason about the cause of a detected anomaly, whether it is indicative of malicious or benign behavior), in performing machine diagnostics (e.g., diagnosing faults and other issues in production or manufacturing machinery, vehicles, aircraft, computer systems, or the like), and in improvements in image processing (e.g., more accurate image classification, image segmentation, object detection, bounding box detection, and so forth).

Example solutions for fine-tuning a language model include: creating a dataset that includes a plurality of paired samples, each paired sample of the plurality of paired samples includes (i) a factual question and a true outcome for that factual question and (ii) a counterfactual question and a true outcome for that counterfactual question; submitting a factual query to an answer model, the factual query including the factual question and the true outcome of the factual question; receiving a factual answer from the answer model in response to the factual query; submitting a counterfactual query to the answer model, the counterfactual query including the counterfactual question and the true outcome of the counterfactual question; receiving a counterfactual answer from the answer model in response to the counterfactual query; and performing fine-tuning on a target model using at least the factual question paired with the factual answer and the counterfactual question paired with the counterfactual answer.

Example solutions for fine-tuning a language model include: creating a dataset that includes a plurality of paired samples, each paired sample of the plurality of paired samples includes a factual question and a counterfactual question; submitting a plurality of factual queries to an answer model, each factual query of the plurality of factual queries including the factual question and a different sampling temperature, thereby causing the answer model to vary randomness of output; receiving a plurality of factual answers from the answer model in response to the submitting of the plurality of factual queries; submitting a plurality of counterfactual queries to the answer model, each counterfactual query of the plurality of counterfactual queries including the counterfactual question and a different sampling temperature, thereby causing the answer model to vary randomness of output; receiving a plurality of counterfactual answers from the answer model in response to the submitting of the plurality of counterfactual queries; identifying one or more selected factual answers from the plurality of factual answers, the remaining factual answers of the plurality of factual answers being one or more unselected factual answers; identifying one or more selected counterfactual answers from the plurality of counterfactual answers, the remaining counterfactual answers of the plurality of counterfactual answers being one or more unselected counterfactual answers; and performing fine-tuning on a target model using at least (i) the factual question paired with the one or more selected factual answers and the one or more unselected factual answers and (ii) the counterfactual question paired with the one or more selected counterfactual answers and the one or more unselected counterfactual answers.

### BRIEF DESCRIPTION OF THE DRAWINGS

The disclosed examples are described in detail below with reference to the accompanying drawing figures listed below:

FIG. 1 illustrates an error rate of answers from an LM for an example factual question and a counterfactual question;

FIG. 2 is an example architectural diagram illustrating data flow within an example model tuning (MT) system;

FIG. 3A to FIG. 3D provides illustrates four different modes of generalization in terms of the cause-effect relationships demonstrated during fine-tuning versus the cause-effect relationship that the fine-tuned model is evaluated on;

FIG. 4A and FIG. 4B include two example graphs that illustrate the difference between correctness and causal consistency;

FIG. 5A and FIG. 5B illustrates a fine-tuning method referred to herein as “Supervised CF”;

FIG. 6A and FIG. 6B illustrate a fine-tuning method referred to herein as “Preference-based CF”;

FIG. 7A and FIG. 7B illustrate a fine-tuning method referred to herein as “Preference-based CCF”;

FIG. 8A presents an example hand-crafted puzzle with an original factual question, a causal structure, and a counterfactual question;

FIG. 8B and FIG. 8C present two graphs illustrating in-domain results for the logic problem;

FIG. 9A to FIG. 9D illustrate example generalization results in the candy party puzzle described in FIG. 8A;

FIG. 10 is a table that illustrates average generalization performance across three real-world causal computational reasoning problems;

FIG. 11A to FIG. 11D include graphs that illustrate the causal structure and fine-tuning/evaluation relations for the Healthcare problem;

FIG. 12A to FIG. 12D include graphs that illustrate the causal structure and fine-tuning/evaluation relations for the Engineering problem;

FIG. 13A to FIG. 13C include graphs that illustrate the causal structure and fine-tuning/evaluation relations for the Math Benchmarking problem;

FIG. 14A, FIG. 14B, and FIG. 14C show the results of the three problems presented above;

FIG. 15A, FIG. 15B, and FIG. 15C present example algorithms and associated pseudo-code for generating datasets [symbol] for the fine-tuning methods shown in FIG. 5A, FIG. 6A, and FIG. 7A, respectively;

FIG. 16 is a flowchart of an example process for fine-tuning GAI models such as the target model of FIG. 5A;

FIG. 17 is a flowchart of an example process for fine-tuning GAI models such as the target model of FIG. 6A; and

FIG. 18 is a block diagram of an example computing device (e.g., a computer storage device) for implementing aspects disclosed herein, and is designated generally as computing device.

Corresponding reference characters indicate corresponding parts throughout the drawings. Any of the figures may be combined into a single example or embodiment.

### DETAILED DESCRIPTION

Generative artificial intelligence (GAI) models that exhibit greater performance in computational reasoning provide improved results in technical applications, such as in cybersecurity (e.g., where a selected/modified GAI model is used in a security system to reason about the cause of a detected anomaly, whether it is indicative of malicious or benign behavior), in perform machine diagnostics (e.g., diagnosing faults and other issues in production or manufacturing machinery, vehicles, aircraft, computer systems, or the like), and in improvements in image processing (e.g., more accurate image classification, image segmentation, object detection, bounding box detection, and so forth).

In computational terms, computational reasoning refers to the algorithmic process of deriving conclusions, making judgments, or generating inferences based on a structured set of input data or premises. This process is central to the design and functionality of artificial intelligence systems and is analyzed through various technical frameworks. Symbolic reasoning, for instance, involves the formal manipulation of abstract symbols to represent and solve problems in domains such as logic, mathematics, and knowledge representation. Causal reasoning employs models to map cause-effect relationships, enabling systems to predict and analyze how specific inputs propagate through a system to produce outcomes. Additional reasoning paradigms include inductive reasoning, which employs statistical or pattern-based algorithms to generalize from specific datasets; deductive reasoning, where inference engines apply predefined rules or axioms to evaluate specific cases; and abductive reasoning, which utilizes heuristic methods to hypothesize plausible explanations in scenarios characterized by incomplete or uncertain data.

In the realm of GAI models such as large language models (LLMs), computational reasoning is typically understood to be the ability of these models to demonstrate emergent capabilities that surpass mere statistical pattern recognition in the training set. It entails systematically breaking down problems into a logical sequence of smaller, manageable steps and then processing these steps internally to arrive at accurate conclusions that are grounded in reality. This concept is the foundation for techniques such as chain of thoughts prompting, which aim to teach GAI models how to reason by providing examples where problems are solved through a sequence of smaller steps.

Assessing the computational reasoning abilities of GAI models involves distinguishing between two aspects: the accuracy with which a GAI model solves a problem, and its capacity to analyze, interpret, and process the fundamental elements that lead to a solution. While GAI models are remarkable in using observed patterns from their training data to generate correct answers (e.g., correlations), they sometimes falter when faced with hypothetical/imaginary scenarios that were not part of their training data (e.g., counterfactuals). For example, both GPT-3.5-turbo and GPT-4 can accurately determine the divisibility of numbers by 6, suggesting at first glance that they can reason about divisibility. However, when the questions are framed in a counterfactual manner, only GPT-4 maintains a low error rate, indicating its superior ability to handle such reasoning tasks.

Improved techniques for improving the reasoning capability of LMs are described herein. One practical use of these techniques is improved reasoning and associated outputs. In such applications and examples, the reasoning capabilities of GAI models are improved by performing fine-tuning on the models using both factual questions and counterfactual questions and associated answers.

While computational reasoning can take different forms, example systems described herein focus on causal reasoning as it provides a clear distinction between recall and reasoning. Using a causal language, recall is limited to forming statistical correlations, whereas reasoning involves working with interventions and counterfactuals. As an example, a different kind of reasoning would be symbolic reasoning, which involves manipulating symbols that represent mathematical statements. It has been shown that some GAI models struggle with questions involving counterfactuals compared with purely factual questions, which is how the recall-reason discrepancy manifests itself within the causal domain.

One example application of some aspects of the disclosure is cybersecurity. In LM-supported cybersecurity, it is particularly important that a LM's reasoning capabilities can be improved. For example, in one application, a selected/modified LM is used in a security system to reason about the cause of a detected anomaly, or whether it is indicative of malicious or benign behavior. In such applications, a decision or conclusion made by the selected LM triggers a security action autonomously. In other such applications, a conclusion or decision made by the LM causes a suggested or recommended action to be outputted (e.g., via a user interface, such as a graphical user interface), which is performed in response to user input confirming the action. Examples of security actions include isolating, quarantining, or restricting an entity (e.g., device, user account, file, document, application, process, service, or the like) within a network or other system.

Other example applications include the use of a fine-tuned LM to perform machine diagnostics, such as diagnosing faults and other issues in production or manufacturing machinery, vehicles, aircraft, computer systems (e.g., computers, user devices, servers, data centers), and the like.

Another example application is computer vision, such as image processing or processing of ‘visual’ spatial sensor data more generally (e.g., lidar, radar, and so forth). Conventional computer vision is based on statistical pattern recognition. For example, previous advances in computer vision have been driven by learned features in convolutional neural network architectures. However, improvements in image processing (e.g., more accurate image classification, image segmentation, object detection, bounding box detection, and so forth) can be achieved with an LM that is capable of reasoning about the visual contents of an image captured in its pixel values. Specific examples include medical imaging and diagnostics based on physiological sensor measurements, where improved LM reasoning ability translates to improved diagnostics.

Another example application is signal processing, such as processing of audio data or other forms of sensor data. The same principles as described in the previous paragraphs apply equally to the processing of other types of functional data, such as audio data, motion sensor data, physical measurements collected in a technical system (e.g., manufacturing system, vehicle, aircraft, or other machines), physiological measurements collected from a human or other living being (e.g., to support a diagnostics application).

Another example application is data generation. In such applications, an instruction to generate a certain type of data (e.g., synthetic image data, audio data, other sensory data) is inputted to a fine-tuned LM, improved in its reasoning capabilities via use of both factual and counterfactual questions and answers (e.g., a natural language prompt describing an image to be generated). Improved data generation performance is achieved by an LM that has better reasoning about the instruction given to it.

While many of the examples provided herein are described in relation to language models, such as LLMs, other types of generative AI models can exhibit reasoning capabilities, and thus can be the subject of the systems and methods described herein. For example, some transformer models are configured with specialized reasoning enhancements, such as DeepMind AlphaCode, OpenAI Codex, or Google Gemini, and can perform symbolic and mathematical reasoning, reason over code, logic puzzles, and structured problems, and may incorporate retrieval-augmented generation (RAG), but can struggle with long-term consistency in reasoning chains. Neurosymbolic AI models, such as IBM Neuro-Symbolic AI and DeepMind AlphaGo, combine symbolic logic (e.g., explicit rules) with deep learning (e.g., pattern recognition), perform deductive and inductive reasoning, and are effective in rule-based problem-solving tasks (e.g., proving theorems, planning). Graph Neural Networks (GNNs), such as DeepMind AlphaFold and Google GraphCast, can infer relationships between entities in a structured format, which can be used for causal and relational reasoning (e.g., predicting molecular interactions, knowledge graphs) and for physical reasoning (e.g., predicting object behavior in physics simulations). Bayesian Networks and Probabilistic Models, such as Probabilistic Graphical Models (PGMs) and Hidden Markov Models (HMMs), can perform causal reasoning and probabilistic interference, which is useful for uncertainty modeling and decision-making under ambiguity. Reinforcement Learning (RL) models, such as AlphaZero, MuZero, and OpenAI Proximal Policy Optimization (PPO), can perform strategic reasoning in dynamic environments, demonstrate decision-making under uncertainty, and can be effective for long-term planning (e.g., board games, robotics), but often struggle with generalization across diverse tasks. Accordingly, the systems and methods described herein can be applied to such types of GAI models and can be similarly applied to improve performance in computational reasoning of such model types.

Additional technical details, examples, and technical benefits are described below with regard to the figures.

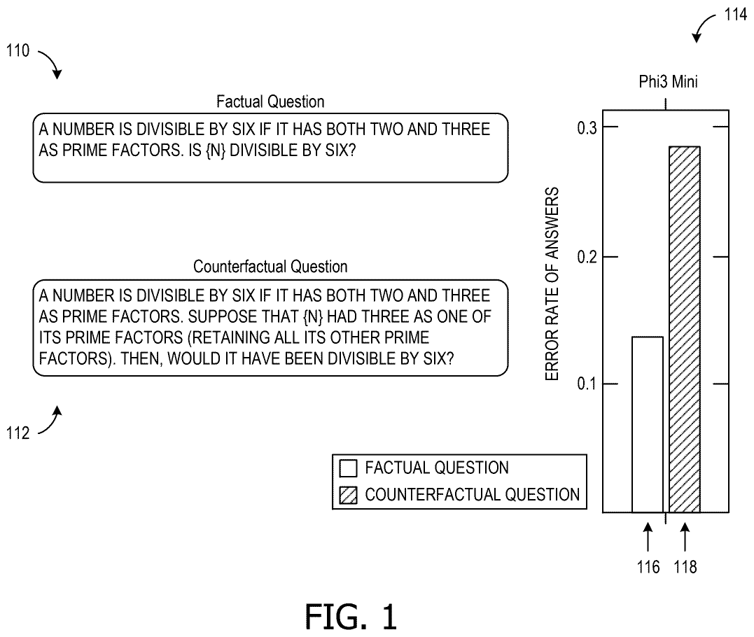

FIG. 1 illustrates an error rate of answers from an LM for an example factual question 110 and a counterfactual question 112. In this example, the error rate of the LM Phi3-Mini is shown in bar graph 114 answering the example factual and counterfactual questions, sampling 10 answers for each N∈{1, . . . , 100}. The factual error rate shown in column 116 illustrates the LM performing disproportionately better for the factual question 110 (e.g., recall) than the counterfactual error rate shown in column 118 for the counterfactual question (e.g., reasoning).

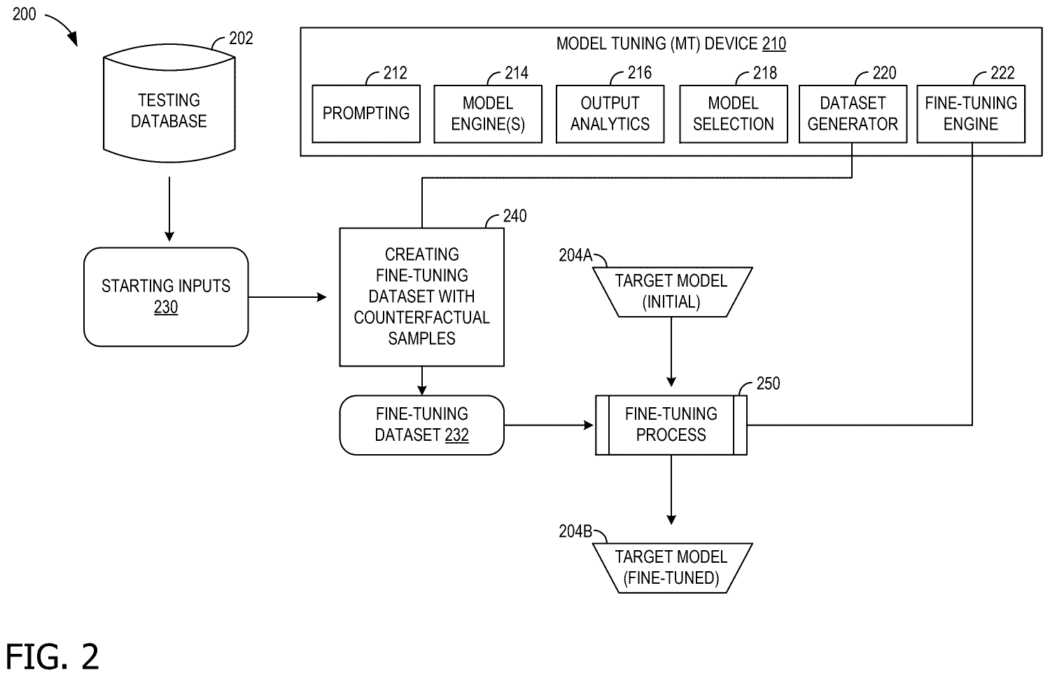

FIG. 2 is an example architectural diagram illustrating data flow within an example model tuning (MT) system 200. In examples described herein, the MT system 200 and methods are provided to fine-tune the reasoning performance of GAI models (e.g., LLMs) based on both factual and counterfactual queries. More specifically, in the example, a model tuning (MT) device 210 generates starting inputs 230 (e.g., factual queries and counterfactual queries) and creates a fine-tuning dataset 232 from those starting inputs 230 that are then used to fine-tune an initial target model 204A into a fine-tuned target model 204B (collectively, target model 204) that exhibits improved computational reasoning.

In the example, the MT device 210 includes a dataset generator 220 that is configured to generate the testing inputs 230 (e.g., pairs of factual and counterfactual queries, not separately shown in FIG. 2), such as the factual question 110 and the counterfactual question 112 shown in FIG. 1, as well as create 240 the fine-tuning dataset 232 with factual and counterfactual samples from those starting inputs 230. The MT device 210 also includes a fine-tuning engine 222 that is configured to perform a fine-tuning process 250 on the initial target model 204A using the fine-tuning dataset 232, thereby resulting in the fine-tuned target model 204B. Various methods for generating the starting inputs 230 and creating 240 the fine-tuning dataset 232 are described below, as well as methods for the fine-tuning process 250.

In the example, the MT device 210 also provides prompting 212 that facilitates submitting various queries to the model 204A, 204B (e.g., as a part of the fine-tuning process 250, or as further described in various methods below). The MT device 210 also provides model engine(s) 214 (e.g., one or more of the models 204 themselves, and their associated data structures, processing, and so forth). In some examples, the MT device 210 provides output analytics 216 that are configured to analyze the outputs generated by the models 204. Model selection 218 uses analytics values to evaluate the models 204 (e.g., selecting model(s) 204 for evaluation of future prompts, perhaps where computational reasoning performance is particularly significant, such as in counterfactual prompts). A testing database 202 is provided for storing starting inputs 230, fine-tuning datasets 232, outputs, and/or analytics values generated by the MT system 200.

Adopting a causal framework allows the example MT system 200 to consider the performance of a GAI model when identifying higher concepts that are significant for connecting causes to their effects in causal reasoning, such as necessity and sufficiency. For instance, a cause X is said to be necessary for an effect Y if (i) without intervention, X and Y occur together and (ii) intervening to remove X results in no Y. Therefore, for a model to be able to identify that X is necessary for Y, it needs to not only determine the factual in (i) is indeed the case but also simultaneously recognize the counterfactual would have been different as in (ii). This makes identification of necessity, or similar relationships like sufficiency, a particularly good test of reasoning because it relies upon the model to understand when to recall (e.g., factual thinking) vs. when to reason (e.g., counterfactual thinking).

The example system 200 described herein improves the causal reasoning of GAI models by improving fine-tuning methods. In particular, the MT system 200 performs procedures to generate supervised and preference-based datasets using factual questions as well as counterfactual questions. Generating demonstrations on a question-by-question basis serves to improve the correctness of individual answers. Identifying higher concepts such as necessity and sufficiency leverages coordination between how factual and counterfactual questions are answered together. To target these higher concepts directly, the system generates preference-based datasets over dialogues involving both factual and counterfactual questions.

When the goal of fine-tuning is specifically to improve reasoning, a unique problem arises in evaluating the fine-tuned models. More specifically, the MT system 200 does not just measure performance for a held-out set of test samples within the same reasoning task, because it would be difficult to tell whether the model actually learned to reason or whether it is still recalling the demonstrations made during fine-tuning. For example, chain-of-thought prompting aims to improve reasoning by providing examples of how a problem can be solved in smaller steps. However, while such prompting can be effective, its effectiveness can be attributed to successful imitation of the provided examples and is not necessarily the result of computational reasoning. Hence, measuring the generalization performance with respect to new reasoning tasks becomes important. It is not expected that fine-tuning on one problem instance arbitrarily generalizes to all problem instances. As such, building a systematic understanding regarding to what extent fine-tuning for reasoning should be expected to generalize becomes important as well.

To build that understanding, the example MT system 200 identifies different modes in which reasoning in one problem is transferred to other problems. Notably, the MT system 200 defines inductive generalization and deductive generalization. Given a causal system where X→Y→Z, inductive generalization is the ability to reason about the transitive relationship X→Z when demonstrated how to reason about X→Y and Y→Z. Conversely, deductive generalization is the ability to reason about the relationships X→Y and Y→Z when demonstrated how to reason about X→Z. Here, fine-tuning for reasoning generalizes much more effectively in an inductive mode rather than a deductive mode.

The example system and methods described herein provide a framework for fine-tuning based on causal reasoning and formally categorize the ways in which reasoning generalizes from one problem to another. These categories are “common-effect,” “common-cause,” “inductive,” and “deductive.” Further, novel metrics are also introduced to measure the computational reasoning performance of GAI models, defining necessity inconsistency rates (N-IR) and sufficiency inconsistency rates (S-IR) based on probabilities of necessity and sufficiency. Moreover, the concepts of “absent necessity” and “absent sufficiency” are introduced to supplement cause-effect relationships covered neither by necessity nor sufficiency.

The example MT system 200 and methods described herein also provide procedures to generate datasets (e.g., fine-tuning dataset 232) to be used with supervised fine-tuning (SFT) and direct policy optimization (DPO) to fine-tune for reasoning by incorporating counterfactual feedback. In particular, the MT system 200 generates dialogues that involve paired factual and counterfactual questions to directly target the computational reasoning performance metrics described herein. Using this approach, the MT system 200 provides a novel method referred to herein as causally consistent feedback (CCF). Further, the performance of these procedures are also evaluated using the computational reasoning performance metrics described herein, and the extent that performance generalizes in relation to these categorizations is shown.

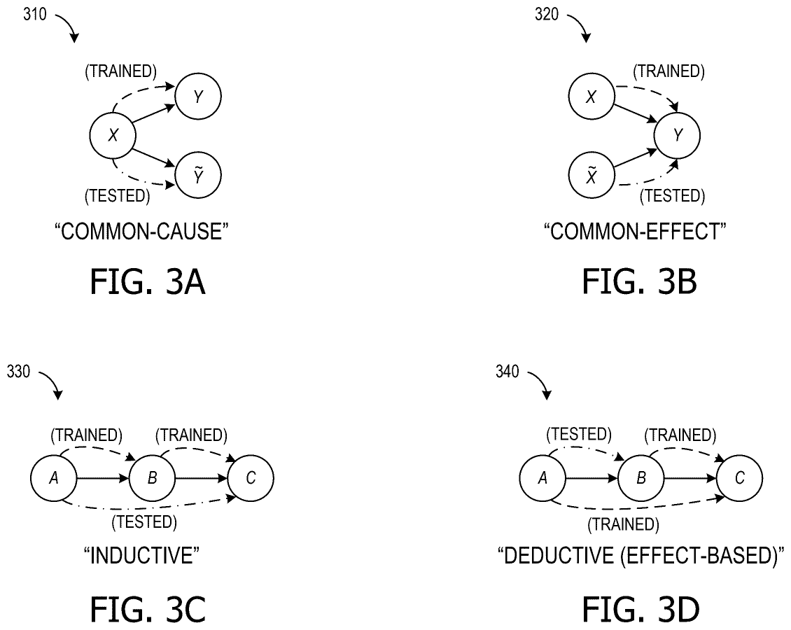

FIG. 3A to FIG. 3D illustrate four different modes of generalization in terms of the cause-effect relationships demonstrated during fine-tuning (e.g., [symbol] , as “trained”) versus the relationship that the fine-tuned model is evaluated on (e.g., [symbol] _{x-y}, as “tested”). More specifically, graph 310 of FIG. 3A illustrates a “common-cause” mode of generalization, graph 320 of FIG. 3B illustrates a “common-effect” mode of generalization, graph 330 of FIG. 3C illustrates a “inductive” mode of generalization, and graph 340 of FIG. 3D illustrates a “deductive (effect-based)” mode of generalization.

In examples, consider a causal world model, in which X (cause) and Y (effect) are two binary variables indicating the absence or presence of some conditions. As such, x, y are denoted as the values taken by X and Y, respectively, when the conditions they represent are present, and with x′, y′ the complements of these values (e.g., the values taken by X and Y when the conditions they represent are absent). The context, denoted by U, consists of all exogenous variables. Without any loss of generality, it is assumed that all randomness in the model is captured through these exogenous variables, and all endogenous variables, including X and Y, are deterministic functions of the exogenous variables (e.g., the context U). These deterministic functions are denoted herein as X=f_{X}(U) and Y=f_{Y}(X, U). Further denoted are the “potential effects” under the potential interventions for each unit in the population as Yₓ=Y|do(X=x)=f_{Y}(x, U) and Yₓ′=Y|do(X=x′)=f_{Y}(x′, U).

In examples, the MT system 200 estimates potential effects using a language model (e.g., target model 204). Formally, let q(u) be a factual question template that describes the world model in natural language and asks what the factual effect would be for a specific context u. (e.g., as in factual question 110 of FIG. 1). Denoting the language model by [symbol] , let a= [symbol] (q(u)) be the model's answer to this question, which will be in natural language form. To transform the answer into binary form, the system uses a mapping h such that Ŷ=h(a)=h( [symbol] (q(u)))∈{y, y′}. Similar to the factual case, the MT system 200 also uses interventional question templates \tilde{q}ₓ(u) and \tilde{q}ₓ′(u) that describe the world model. However, these templates ask for the potential effects under interventions do(X=x) or do(X=x′). This leaves the following estimates for the two potential effects. For a given context u, the MT system 200 relies on the factual question template when the effect is factual, and on the interventional question template when the effect is counterfactual:

$${\hat{Y}}_{x} = \{ \begin{matrix}h ∘ ℓ ∘ q ( U ) & if X = x \\ h ∘ ℓ ∘ {\tilde{q}}_{{x}^{′}} ( U ) & if X = {x}^{′}\end{matrix} \qquad ( 1 )$$

$${\hat{Y}}_{{x}^{′}} = \{ \begin{matrix}h ∘ ℓ ∘ {\tilde{q}}_{x} ( U ) & if X = x \\ h ∘ ℓ ∘ q ( U ) & if X = {x}^{′}\end{matrix}$$

Problem: Let [symbol] describe the context distribution such that U˜ [symbol] . Moreover, let [symbol] _{X→Y} denote the corresponding distribution of cause X=f_{X}(U) and potential effects Y_{X}(U)=f_{Y}(x,U), Yₓ′(U)=f_{Y}(x′, U) such that X, Yₓ, Yₓ′˜P_{X→Y}. If optimizing some metric [symbol] [ [symbol] ; [symbol] _{X→y}]∈ [symbol] that measures the computational reasoning performance of the language model [symbol] for the cause-effect relationship [symbol] _{X→Y} (the design of [symbol] is discussed in further detail below), the problem of fine-tuning for reasoning can be expressed as:

$$\begin{matrix}maximize & 𝕍 [ ℓ ; {𝒫}_{X \to Y} ] & given & {ℓ}_{0} , 𝒫 , 𝒟 = {\{ {𝒫}_{{X}_{i} \to {Y}_{i}} \}}_{i}\end{matrix} \qquad ( 2 )$$

where [symbol] ₀ is the target language model, and [symbol] is the set of different cause-effect relationships [symbol] _{X}_{ᵢ}_{→Y}_{ᵢ} that are available as demonstrations. These relationships may involve causes {Xᵢ} and effects {Yᵢ} other than the cause X or the effect Y of interest. The case where only the cause-effect relationship of interest is demonstrated such that [symbol] ={ [symbol] _{X→Y}} is referred to herein as the “in-domain” problem.

As discussed above, an in-domain evaluation may not alone be sufficient to assess the success of fine-tuning for computational reasoning performance. Therefore, the MT system 200 categorizes different ways in which reasoning can generalize—that is, how [symbol] might relate to [symbol] _{X→Y} when [symbol] _{X→Y}∉ [symbol] . Four main structures are shown in FIG. 3A to FIG. 3D. More specifically, the graph 310 illustrates “Common-Cause” generalization. When the relationship X→Y is demonstrated, common-cause generalization refers to the ability to reason about other relationships X→\tilde{Y} that involve the same cause X. The graph 320 illustrates “Common-Effect” generalization. When demonstrated the relationship X→Y, common-effect generalization refers to the ability to reason about other relationships \tilde{X}→Y that involve the same effect Y. Unlike common-cause generalization, here the task of determining the factual effect without intervention remains the same, regardless of whether X or \tilde{X} is the cause of interest. The graph 330 illustrates “Inductive” generalization. When demonstrated the relationship A→B and B→C, inductive generalization is the ability to reason about the transitive relationship A→C. This ability may be hindered if A has a direct effect on C that is not mediated by B. This scenario is discussed and investigated empirically below. The graph 340 illustrates “Deductive” generalization. Similar to inductive generalization, consider the causal relationship A→B→C. When the relationships A→C and B→C are demonstrated, effect-based deductive generalization is the ability to reason about the relationship A→B. Similarly, when the relationships A→C and A→B are demonstrated, cause-based deductive generalization is the ability to reason about the relationship B→C.

Having defined the problem of fine-tuning for reasoning, next discussed is a measure of reasoning ability (e.g., a good choice for [symbol] ). Below, error rates are defined based on the correctness of answers given by the language model to individual questions. Further, going beyond these simple error rates, various inconsistency rates are described that capture the causal consistency between the factual and counterfactual answers given within the same context. Such consistency is beneficial in identifying causal relationships such as necessity and sufficiency. Additionally, various methods for generating datasets (e.g., fine-tuning dataset 232) are described herein that aim to optimize either of these metrics.

Ignoring the relationship between factual and counterfactual effects, the correctness of an individual answer a= [symbol] ºq(u)| [symbol] º\tilde{q}ₓ(u)| [symbol] º\tilde{q}ₓ′(u) can be characterized by the factual error rate (F-ER) and the counterfactual error rate (CF-ER) respectively:

$$F - ER = ℙ \{ \hat{Y} \neq Y \} \qquad ( 3 )$$

$$CF - ER = ℙ \{ \begin{matrix}{\hat{Y}}_{{x}^{′}} \neq {Y}_{{x}^{′}} & if X = x \\ {\hat{Y}}_{x} \neq {Y}_{x} & if X = {x}^{′}\end{matrix} \qquad ( 4 )$$

where Ŷ, Ŷₓ, and Ŷₓ′ represent the binary values implied by the answer a. Using these two metrics, the average error rate is defined as Avg-ER=(F-ER+CF-ER)/2.

Being able to correctly estimate factuals (e.g., F-ER) or counterfactuals (e.g., CF-ER) is a significant step in causal reasoning. However, what is ultimately desired is to characterize the relationship between a cause and its effect. For instance, is the cause necessary for the effect to occur? Is it sufficient? Or do the cause and the effect only occur together (e.g., necessary and sufficient)? Identifying such relationships relies on the estimated factuals and counterfactuals collectively. Only getting one right but not the other might not always lead to a correct characterization of the cause-effect relationship. By measuring the factual and counterfactual accuracy separately, F-ER and CF-ER fail to capture any dependencies between the two answers and how they might be describing a larger relationship together.

As a concrete example, consider necessity. When a cause X and an effect Y occur together (i.e., X=x and Y=y), the cause is said to have been necessary for the effect if the effect would not have occurred in the absence of the cause (i.e., Yₓ′=y′). Making an accurate judgement regarding whether there is a necessity relationship between X and Y requires both Ŷ and Ŷₓ′ to be correct when X=x and Y=y. However, no factual or counterfactual estimate needs to be correct when X=x′ (as it is immediately apparent that cases where X=x′ do not affect necessity), and similarly, only the factual estimates need to be correct when X=x but Y=y′. F-ER and CF-ER do not account for this complex requirement at all. In particular, depending on how X and Y are distributed, a language model can achieve F-ER and CF-ER as high as ½ by always estimating either Yₓ or Yₓ′ correctly (but not both together) while never reaching an accurate conclusion regarding necessity.

One way to address this issue with correctness as a metric of reasoning by making use of “probabilities of causation.” One causal definition of sufficiency is: whether the cause would have produced the effect (i.e., Yₓ=y) when both the cause and the effect are absent (i.e., X=x′ and Y=y′). Then, the probability of necessity (PN) and the probability of sufficiency (PS) are defined as:

$$PN := ℙ \{ {Y}_{{x}^{′}} = {y}^{′} \vert X = x , Y = y \} \qquad ( 5 )$$

$$PS := ℙ \{ {Y}_{x} = y \vert X = {x}^{′} , Y = {y}^{′} \} \qquad ( 6 )$$

The answers given by the language model to factual and counterfactual questions and the effects Ŷₓ, Ŷₓ′ estimated from those answers naturally induce an empirical pair of PN and PS values:

$$= ℙ \{ {\hat{Y}}_{{x}^{′}} = {y}^{′} \vert X = x , \hat{Y} = y \} \qquad ( 7 )$$

$$= ℙ \{ {\hat{Y}}_{x} = y \vert X = {x}^{′} , \hat{Y} = {y}^{′} \} \qquad ( 8 )$$

To evaluate computational reasoning performance in language models, the MT system 200 uses (1) a probabilistic measure (Y-overlap) to assess how well the distributions of [symbol] and [symbol] match the true PN and PS, and (2) the factual and counterfactual error rates. This approach is further improved by defining unifying metrics that simultaneously take both aspects of the problem into account, thereby simplifying the evaluation process.

Due to the averaging done by probabilities, achieving a perfect PN-PS with the language model (e.g., target model 204) relies upon identifying correct versus predicted marginal frequencies, without needing individual units to be accurate. Although this is captured by the factual and counterfactual error rates F-ER and CF-ER, it is convenient to have a single metric that encapsulates both dimensions of the problem. This is addressed by requiring the necessity or sufficiency relationship identified by the language model to be accurate on a unit-by-unit basis. A unit is a realization of the exogenous variable U. It induces the values of X and Y as well as the counterfactual outcome Y_{X}′, where X′ represents the complement of the observed X regardless of its value. Note that Yₓ=Y is the factual outcome.

In examples, the MT system 200 focuses on necessity where a unit/context might exhibit one of three situations: (i) necessity occurs, denoted by “ [symbol] ”, meaning that both X and Y occur, X=x and Y=y, and the cause was necessary for the effect, Y_{X}′=y′; (ii) necessity does not occur, which is denoted by “ [symbol] ′”, meaning that both X and Y occur but the cause was not necessary for the effect, Y_{X}′≠y′; and (iii) a not relevant case as necessity is concerned, which is denoted by Ø, when neither X nor Y (or both) occurred. Since value of the context variable U fully characterizes the unit, unit-wise necessity is defined as:

$$𝒩 ( X , Y , {Y}_{{X}^{′}} ; U ) = \{ \begin{matrix}ℕ & if X = x \hat{} Y = y \hat{} , {\hat{Y}}_{{x}^{′}} = {y}^{′} \\ ℕ & if X = x \hat{} Y = y \hat{} , {\hat{Y}}_{{x}^{′}} \neq {y}^{′} \\ ∅ & if X = {x}^{′} \hat{} Y = {y}^{′}\end{matrix} \qquad ( 9 )$$

The necessity inconsistency rate (N-IR) is the frequency with which the language model estimates the unit-wise necessity [symbol] inaccurately:

$$N - IR := {𝔼}_{𝒫 ( U )} [ 𝒩 ( X , \hat{Y} , {\hat{Y}}_{{X}^{′}} ; U ) \neq 𝒩 ( X , Y , {Y}_{{X}^{′}} ; U ) ] , \qquad ( 10 )$$

where [symbol] denotes the expectation over U and Ŷ, Ŷ_{X}′ are the analogous factual and counterfactuals to Y, Y_{X}′ estimated from the model. Remark that PN= [symbol] _{P(U)}[ [symbol] = [symbol] | [symbol] ≠Ø] by construction. Also note that N-IR=0 implies that [symbol] =PN. However, errors made in different units can no longer ‘balance each other out’ to achieve N-IR=0. Context-wise sufficiency S can also be defined in an analogous way: (i) [symbol] = [symbol] if X=x′, Y=y′, Y_{X}′=y, (ii) [symbol] = [symbol] ′ if X=x′, Y=y′, Y_{X}′≠y, and (iii) [symbol] =Ø otherwise. This induces the sufficiency inconsistency rate S-IR= [symbol] { [symbol] ‥ [symbol] }.

Neither PN and PS nor inconsistency rates N-IR and S-IR are sensitive to all answers given by the language model. This is because necessity and sufficiency only concern cases where X=x, Y=y, X=x′, and Y=y′. For instance, when X=x′ and Y=y and the factual effect has been estimated correctly such that Ŷ=Y, the counterfactual estimate Ŷₓ has no impact on PN, PS, N-IR, or S-IR. Regardless of whether Ŷₓ=Yₓ, all four quantities stay the same. To cover all possible counterfactuals that can be asked of the language model, it makes sense to also evaluate counterfactuals of the type Yₓ′=y|X=x, Y=y′ and Yₓ=y′|X=x′, Y=y. Of course, the probabilities of these counterfactuals can be defined by means of PN and PS by changing the default observed state. However, these are named as ‘absent necessity’ and ‘absent sufficiency’ herein, to be explicit about the two extra cases where the language model can make mistakes. In this context-based framework, the corresponding context-wise [symbol] and [symbol] are defined in a similar fashion to [symbol] and [symbol] , which induce the inconsistency rates AN-IR= [symbol] { [symbol] ≠ [symbol] } and AS-IR= [symbol] { [symbol] ≠ [symbol] }. As a reasoning metric, the average inconsistency rate is defined as Avg-IR=(N-IR+S-IR+AN-IR+AS-IR)/4. This metric has the following properties: (i) it accounts for all characterizations of the necessity and sufficiency of the target causal effect; and (ii) it is unit-dependent, so factual and counterfactual accuracy errors cannot be balanced out.

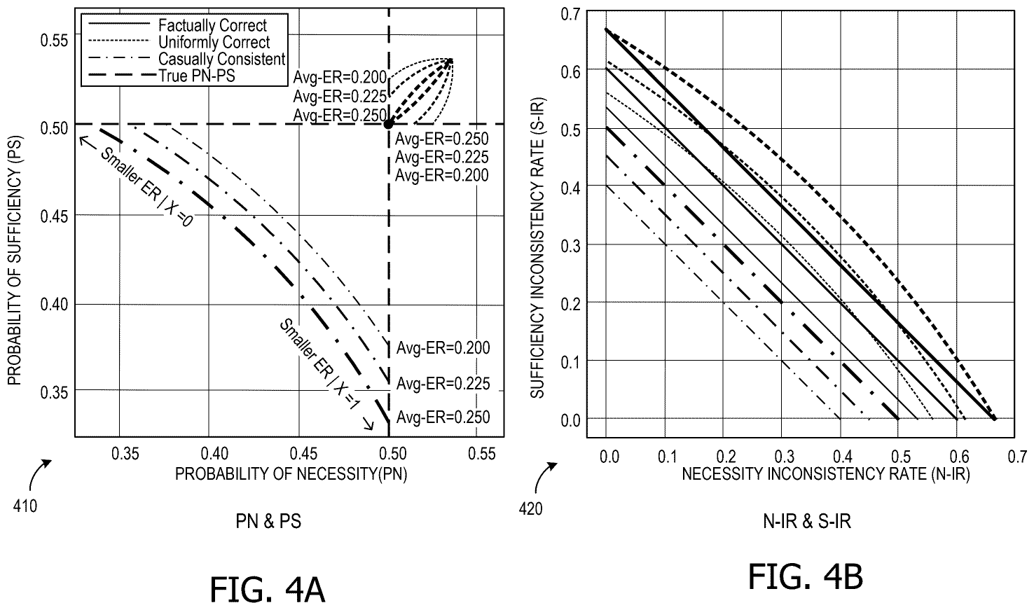

FIG. 4A and FIG. 4B include two example graphs 410, 420 that illustrate the difference between correctness and causal consistency. In the example, consider the following language models: (i) “Factually Correct” answers all factual questions correctly (e.g., F-ER=0) but makes occasional mistakes in answering counterfactual questions. This represents an extreme version of the imbalance highlighted above. (ii) “Uniformly Correct” makes both factual and counterfactual mistakes at equal rates (e.g., F-ER=CF-ER), but these mistakes happen independently of each other. “Causally Consistent” reasons on a unit-by-unit basis (as opposed to question-by-question basis) and either gets both the factual question and counterfactual question right or gets both of them wrong. For example, the cause never prevents the effect such that (X, Yₓ, Yₓ′)∈{(x, y′, y′), (x, y′, y), (x, y, y), (x′, y′, y′), (x′, y′, y), (x′, y, y)} (with equal probabilities).

In the example, FIG. 4A shows the PN and PS as well as N-IR and S-IR of these models for fixed levels of Avg-ER as the error shifts between contexts where the cause may be necessary (e.g., X=x) versus contexts where it may be sufficient (e.g., X=x′). Despite having the same Avg-ER, the three models induce widely different PN and PS values, representing widely different causal interpretations. While the graph 410 of FIG. 4A might suggest that the factually correct models are the best performing, this is purely coincidental. Due to the averaging done by PN and PS, the mistakes made in different units end up balancing each other out. Looking at N-IR and S-IR in the graph 420 of FIG. 4B reveals that the causally consistent models are actually the best, even outperforming models with significantly smaller Avg-ER.

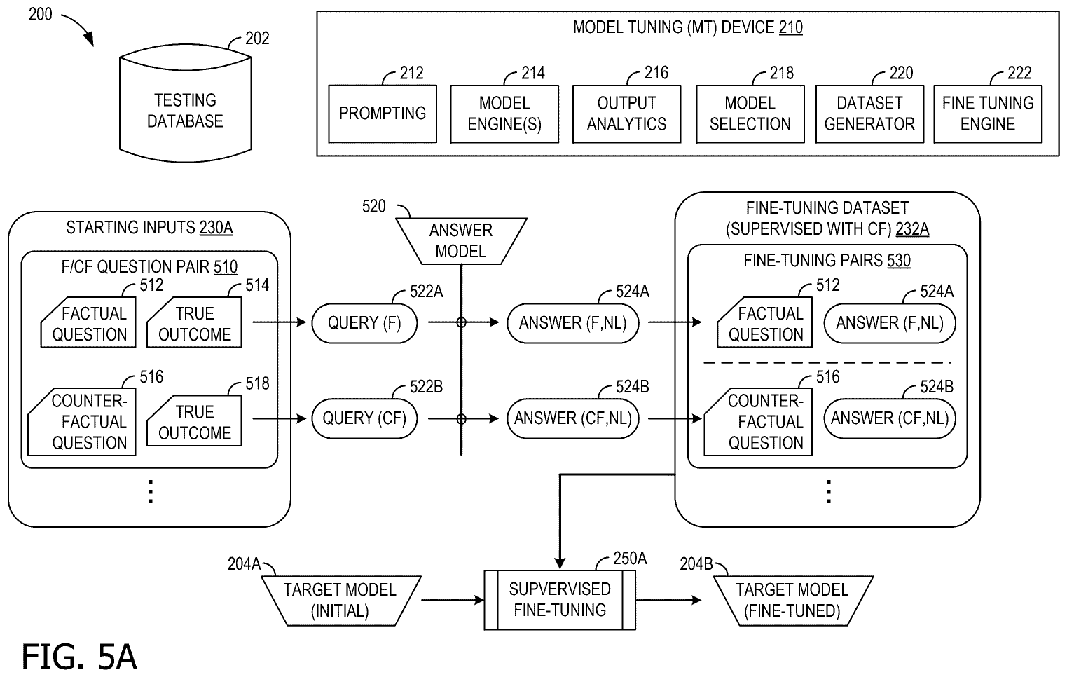

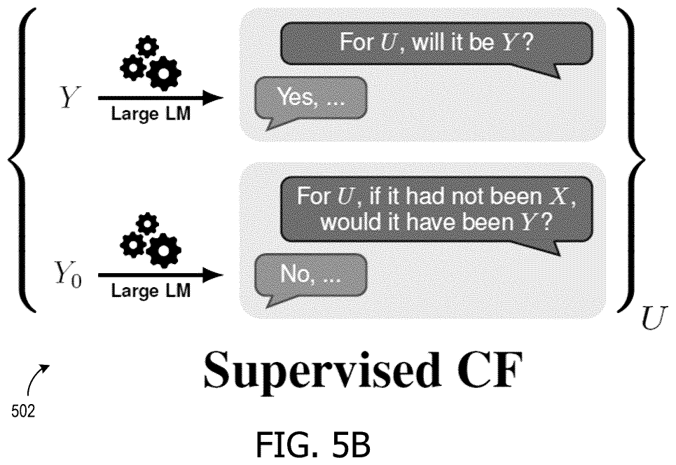

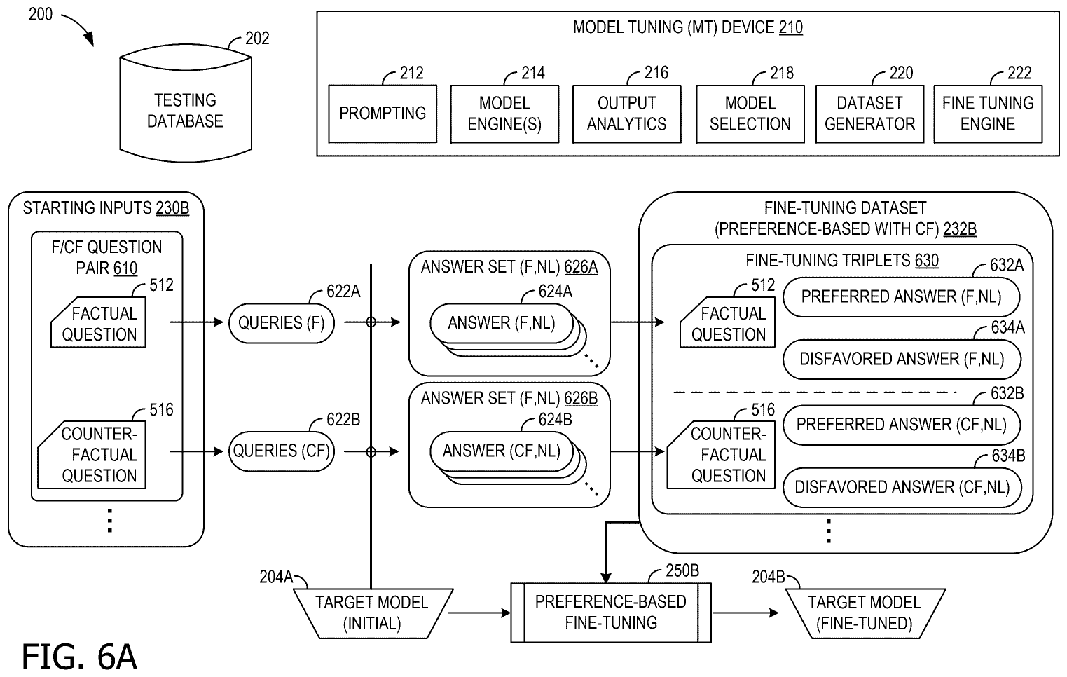

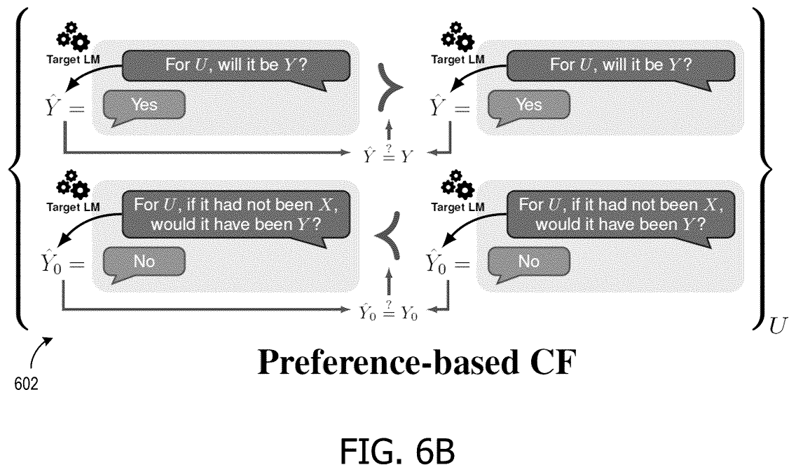

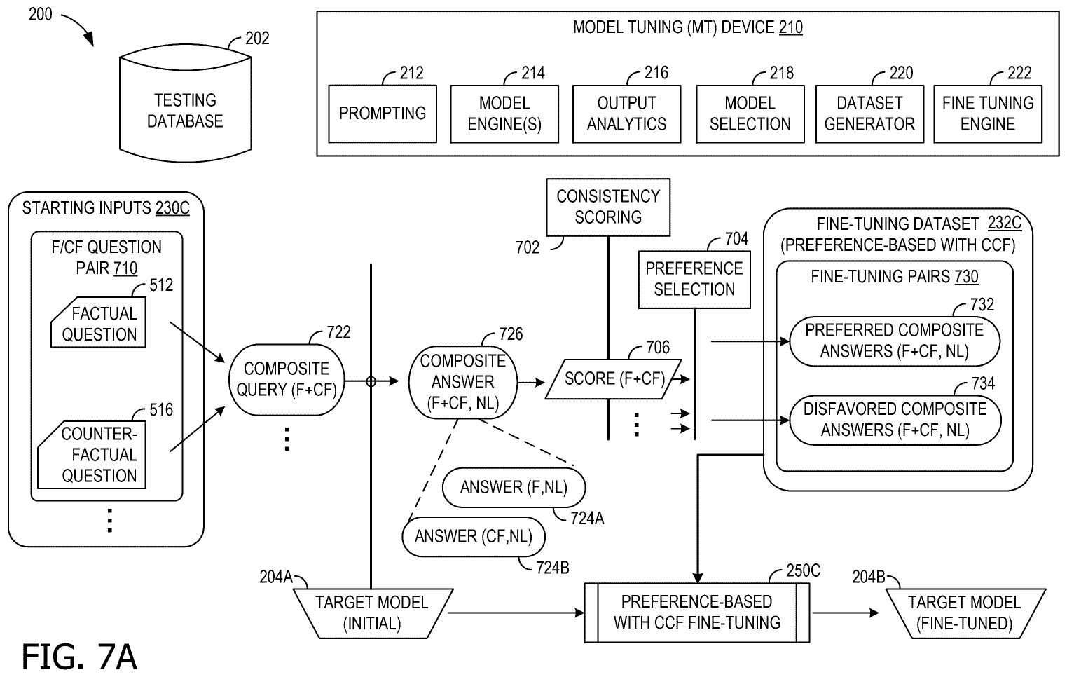

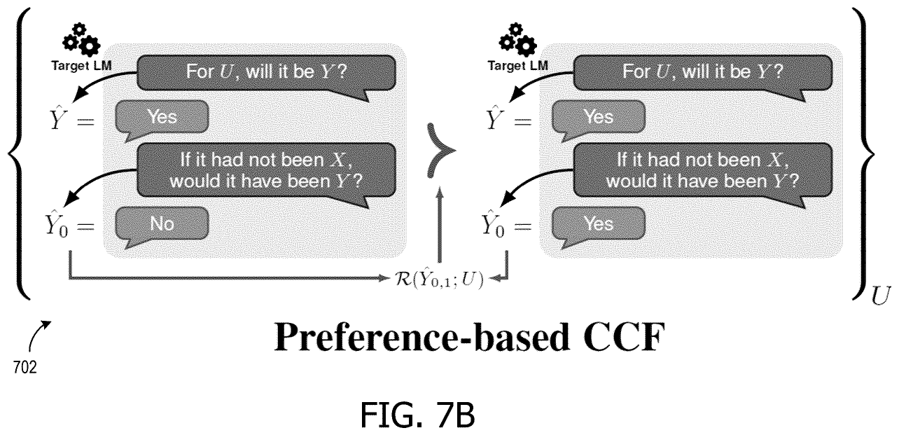

FIG. 5A to FIG. 7B illustrate a summary of three methods for generating training datasets using counterfactual feedback and using those fine-tuning datasets with various fine-tuning methods to fine tune the target model 204. More specifically, FIG. 5A and FIG. 5B illustrates a method referred to herein as “Supervised CF”, FIG. 6A and FIG. 6B illustrate a method referred to herein as “Preference-based CF”, and FIG. 7A and FIG. 7B illustrate a method referred to herein as “Preference-based CCF.” For each of the three example methods, architecture and dataflow diagrams are shown in FIG. 5A, FIG. 6A, and FIG. 7A, with example dataflows 502, 602, 702 for each method in FIG. 5B, FIG. 6B, and FIG. 7B, respectively.

Regarding “Preference-based CF” and “Preference-based CCF”, it should be understood that the term “preference” is used to indicate a selection of some elements (e.g., “preferred answers” 632 of FIG. 6A) over other elements (e.g., “disfavored answers” 634 of FIG. 6A) of a set (e.g., “answer set” 626 of FIG. 6A). In some examples, selection criteria are used to identify the preferred elements, such as criteria based on an accuracy score or the like (e.g., accuracy scores exceeding a threshold, the top X answers or top percentage of answers by accuracy score, or the like), where the remainder of elements are the disfavored elements. In some examples, humans (e.g., data scientists) identify the preferred elements over the disfavored elements. Accordingly, the terms “selection” or “selected” elements may be used to describe this “preference” aspect of the methods.

Despite the significant differences between correctness and causal consistency, success in either metric relies on accurate estimates of counterfactual outcome. Therefore, to solve the fine-tuning problem in eq. (2), the MT system 200 leverages the counterfactual information available in demonstrations [symbol] , irrespective of the metric targeted as [symbol] . In examples, a data-centric approach is used to these ends, including these three example methods for generating datasets 232A, 232B, 232C (collectively, “datasets 232”) using counterfactual feedback. These datasets 232 can then be utilized by the fine-tuning engine 222 for fine-tuning (e.g., using supervised fine-tuning (SFT), direct policy optimization (DPO), or other methods described herein).

In the Supervised CF and Preference-based CF examples of FIG. 5A and FIG. 6A, respectively, both target correctness. Supervised CF targets correctness by generating correct answers given each question. Preference-based CF targets correctness by sampling answers and preferring the correct ones over the others. In examples, scoring of the optimization corresponds to eq. (9) and eq. (10) for Supervised CF, and to eq. (11) for Preference-based CF. In both cases, there are two pairs of factual and counterfactuals. In the case of Preference-based CF, the scoring is based on comparing factuals and counterfactuals separately, where each pair gets a point every time one is preferred to the other. In the Preference-based CF, both factuals and counterfactuals in a pair need to be preferred to the ones in the other pair to get a point (and neither get a point if preferences are inconsistent). The Preference-based CCF of FIG. 7A and FIG. 7B targets causal consistency. Asking both the factual and the counterfactual questions within the same dialogue allows the system to elicit preferences according to relationships between the factual and counterfactual answers.

Referring now to FIG. 5A and FIG. 5B, and the example “Supervised CF” method, the MT system 200 creates the starting inputs 230A as a set of factual/counterfactual (F/CF) question pairs 510. More specifically, in the example, each F/CF question pair 510 includes (1) a factual question 512 and its “true outcome” 514 and (2) a counterfactual question 516 and its true outcome 518.

It is assumed the MT system 200 includes an extractor h that can reduce answers (e.g., answers 524) given in natural language to binary outcomes ŷ=h(a)∈{y, y′}. This extraction can be performed in reverse, denoted as H: Given a question q (e.g., factual question 512, counterfactual question 516) and the true outcome yₜᵣᵤₑ corresponding to this question (e.g., true outcomes 514, 518, respectively), a natural-language answer can be formed as a=H (q, yₜᵣᵤₑ). In practice, this is achieved by prompting a language model (e.g., the answer model 520) to provide an answer (e.g., answer 524A, 524B, respectively) to question q (e.g., query 522A, 522B) that starts with “Yes” or “No” (e.g., based on the true outcomes 514, 518 for that particular question 512, 516, respectively). Example prompts are described below. Based on the answers 524A, 524B generated by the answer model 520 in response to the queries 522A, 522B, a dataset D is generated (e.g., fine-tuning dataset 232A) of both factual and counterfactual questions 512, 516 and their answers 524A, 524B (e.g., as fine-tuning pairs 530):

$$𝔻 = {\{ {q}_{f} = q ( U ) , {a}_{f} = H ( {q}_{f} , Y ) , {q}_{cf} = {\tilde{q}}_{{X}^{′}} ( U ) , {a}_{cf} = H ( {q}_{cf} , {Y}_{{X}^{′}} ) \}}_{U , X , Y , {Y}_{{X}^{′}} \sim 𝒟}$$

This dataset 232A is then used with any SFT algorithm (e.g., supervised fine-tuning 250A) to fine-tune the target model [symbol] ₀ (e.g., target model 204).

In examples, supervised fine-tuning uses input-output pairs for fine-tuning the target model 204. In the example shown in FIG. 5A, the factual question 512 and answer 524A represent one input-output pair (as one fine-tuning pair 530), and the counterfatual question 516 and answer 524B represent another input-output pair (as another fine-tuning pair 530). Further fine-tuning pairs 530 are likewise generated for other question pairs 510 of the starting inputs 230A.

SFT can be limited by the quality of answers generated as ground-truth and their similarity to the model's original answers. Without access to a language model that is already better at reasoning than the target model 204, it might be challenging to build an answer generator H that provides high quality samples. In that case, it is desirable to provide direct feedback to the answers generated, as shown in the next example.

Referring now to FIG. 6A and FIG. 6B, and the example “Preference-based CF” method, for each F/CF question pair 610, the MT system 200 first generates multiple answers (e.g., answer sets 626A, 626B of answers 624A, 624B, respectively) to different questions (e.g., queries 622A, 622B, respectively), in some examples using a high sampling temperature to get sufficient variation between answers:

$$𝔻 = \{ U , {q}_{f} = q ( U ) , {a}_{f} [ 1 ] \sim {ℓ}_{0} ( {q}_{f} ) , \text{} … , {a}_{f} [ N ] \sim {ℓ}_{0} ( {q}_{f} ) , {q}_{cf} = {\tilde{q}}_{{X}^{′}} ( U ) , {a}_{cf} [ 1 ] \sim {ℓ}_{0} ( {q}_{cf} ) , … , {a}_{cf} [ N ] \sim {ℓ}_{0} ( {q}_{cf} ) {\}}_{U , X , Y , {Y}_{{X}^{′}} \sim 𝒟} {}_{} \qquad ( 11 )$$

In the example, these queries 622A, 622B are submitted to the target model 204A to generate these answers 624A, 624B. Then, a preference-based dataset (e.g., fine-tuning dataset 232B) is formed where correct answers (e.g., preferred answers 632A, 632B, a first pool of answers also referred to herein as “selected answers” or “high-scoring answers”) are preferred over incorrect answers (e.g., disfavored answers 634A, 634B, a second pool of answers also referred to herein as “unselected answers” or “low-scoring answers”):

$${a}_{f} [ i ] ≻ {a}_{f} [ i ] ⇐ ⇒ \{ h ( {a}_{f} [ i ] ) = Y \} > \{ h ( {a}_{f} [ j ] ) = Y \} \qquad ( 12 )$$

$${a}_{cf} [ i ] ≻ {a}_{cf} [ i ] ⇐ ⇒ \{ h ( {a}_{cf} [ i ] ) = {Y}_{{X}^{′}} \} > \{ h ( {a}_{cf} [ j ] ) = {Y}_{{X}^{′}} \} \qquad ( 13 )$$

The DPO algorithm can directly be used with this dataset 232B to maximize the likelihood of preferred answers 632A, 632B (e.g., a[i]) relative to the answers they are preferred over (disfavored answers 634A, 634B, e.g., a[j]).

In examples, preference-based fine-tuning (e.g., direct preference optimization) uses triplets of data that encode (a) an input, (b) two outputs, and (c) preference data indicating which of the two outputs is preferred over the other. In this example, for any particular fine-tuning pair 630, the input (a) is one of the factual questions 512 or counterfactual questions 516, the two outputs (b) are two of the answers 624 generated by the target model 204 (namely, one of the preferred answers 632 and one of the disfavored answers 634), and the preference data (c) is an indicator identifying the preferred answer 632 over the disfavored answer 634 of the two outputs (e.g., a value of 1.0, −1.0, or the like). In the example shown in FIG. 6A, the factual question 512, the preferred answer 632A, and the disfavored answer 634A represent one triplet (as one fine-tuning triplet 630, along with implied preference data identifying the preferred answer 632A), and the counterfactual question 516, the preferred answer 632B, and the disfavored answer 634B represent another triplet (as another fine-tuning triplet 630, along with implied preference data identifying the preferred answer 632B). Further fine-tuning pairs 630 are likewise generated for other question pairs 610 of the starting inputs 230B.

Running DPO with preferences determined by a reward function, where alternatives with higher rewards (e.g., selecting F/CF answers that are over a predetermined threshold, percentage of highest F/CF answers by reward value, or the like) are preferred over those with lower rewards (e.g., the remaining unselected F/CF answers), is equivalent to maximizing that reward function. In this case, this means that, by running DPO with the above preferences would, in effect, minimize the average error rate (e.g., Avg-ER,) as these preferences are generated by treating correctness (e.g., [symbol] {h(a)=Ŷ=Y}) as a reward function.

Referring now to FIG. 7A and FIG. 7B, and the example “Preference-based CCF” method, in order to the target inconsistency rate discussed above, the MT system 200 (i) pairs factual and counterfactual questions 512, 516 (e.g., as F/CF question pairs 710, combined into a single “composite query” 722), (ii) prompts the target model 204A to answer them simultaneously (e.g., as composite query 722, resulting in composite answer 726 that includes answers 724A, 724B to both questions 512, 516), and then (iii) elicits preferences based on the composite answer 726. Formally:

$$( {a}_{f} [ i ] , {a}_{cf} [ i ] ) ≻ ( {a}_{f} [ j ] , {a}_{cf} [ j ] ) ⇐ ⇒ ℛ ( h ( {a}_{f} [ i ] ) , h ( {a}_{cf} [ i ] ) ; U ) > ℛ ( h ( {a}_{f} [ j ] ) , h ( {a}_{cf} [ j ] ; U ) \qquad ( 14 )$$

where [symbol] (Ŷ, Ŷ_{X′}; U)= [symbol] { [symbol] = [symbol] }+ [symbol] { [symbol] = [symbol] }+ [symbol] { [symbol] = [symbol] }+ [symbol] { [symbol] = [symbol] }. This is referred to herein as causal consistency feedback (CCF). CCF explicitly targets Avg-IR rather than Avg-ER and can still be used directly with the DPO algorithm.

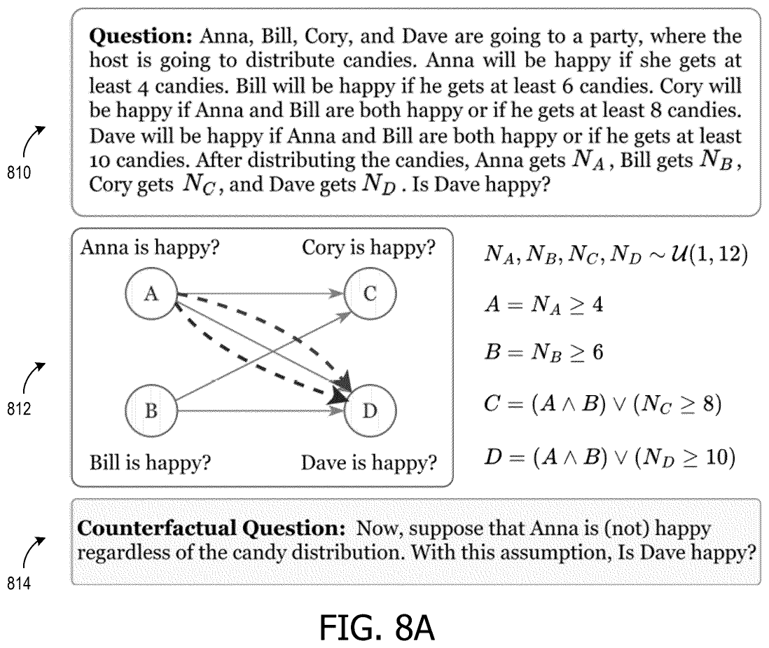

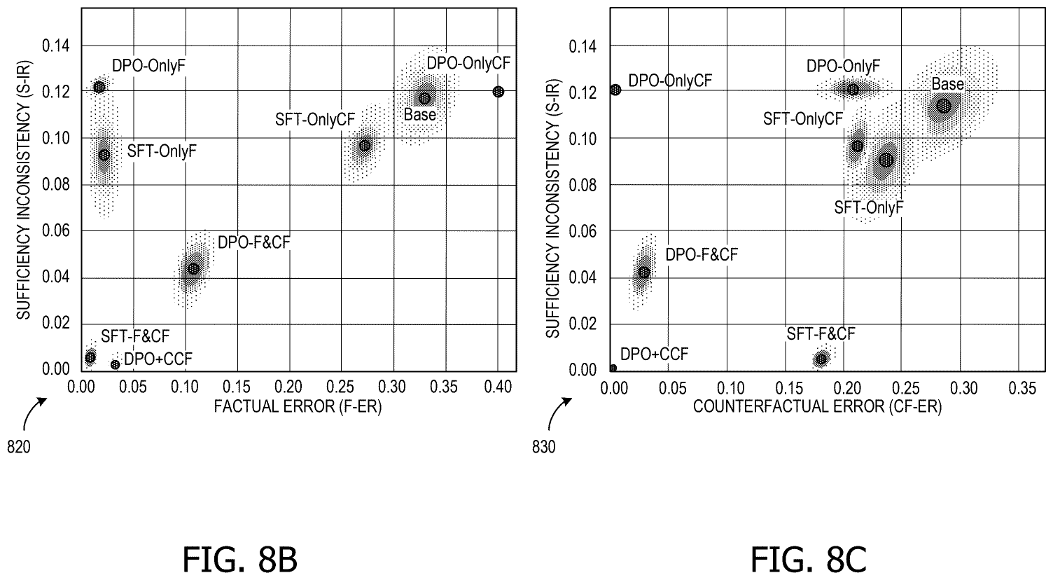

FIG. 8A presents an example hand-crafted puzzle with an original factual question 810, a causal structure 812, and a counterfactual question 814. In the example, broken arrows illustrate the cause-effect interventions demonstrated to the model during fine-tuning and evaluation phases. FIG. 8B and FIG. 8C present two graphs 820, 830 illustrating in-domain results for the logic problem. In the example, the y-axes of graphs 820, 830 represent S-IR, while the x-axes of graphs 820, 830 represent F-ER and CF-ER, respectively. In this example, S-IR is the focus because, in this puzzle, the cause is more sufficient than necessary for producing the effect.

In the example, a proof-of-concept case study is presented. The hand-crafted puzzle (e.g., question 810) is analyzed to assess the effectiveness of various fine-tuning techniques discussed above when trained on different types of datasets within the context of the in-domain causal reasoning scenarios. In addition, the question posed above is also addressed (e.g., to what extent the performance improvements in causal reasoning achieved through the fine-tuning process generalize across all the generalization modes). Further, three additional real-world problems are also used to examine these findings.

In the example shown in FIG. 8A, the question 810 describes a candy party. The context of the question 810 is defined by the four-dimensional random vector U=(N_{A}, N_{B}, N_{C}, N_{D}), where each element follows the same uniform distribution [symbol] . The causal structure 812 is derived from the narratives of the question 810. In the example, “A: Anna is happy or not” is selected as the cause (X), and “D: Dave is happy or not” as the effect (Y). The factual questions q(u) are obtained by randomly drawing values for the four numerical variables from the distribution [symbol] . The counterfactual questions \tilde{q}_{X′}(u) are generated by introducing an assumption that negates the cause (e.g., if in the context A is “Anna is happy” based on the value of N_{A}, the injected assumption would be “suppose that Anna is not happy”, and vice versa). Since the in-domain reasoning scenario is being assessed, the cause-effect demonstration used during the fine-tuning phase is likewise employed in the evaluation phase.

Initially, in this example, a dataset is generated as [symbol] =({(q(u), a_{f})}, {(\tilde{q}_{X′}(u),a_{cf})}) for each of the fine-tuning techniques discussed above following the algorithms discussed below. Then, the mini version of Phi-3 is fine-tuned on D. Five baselines are included: the base language model (e.g., Phi-3 mini) without fine-tuning (“Base”); the base model fine-tuned using the SFT and DPO methods on factual examples {(q(u),a_{f})} exclusively (“SFT-OnlyF” and “DPO-OnlyF”); and the base model fine-tuned using the SFT and DPO methods on counterfactual examples {(\tilde{q}_{X′}(u), a_{cf})} exclusively (“SFT-OnlyCF” and “DPO-OnlyCF”). As the proposed methods, the example includes the base model fine-tuned using SFT, DPO, and CCF methods on both factual and counterfactual examples (“SFT-F&CF” or “Supervised CF”, “DPO-F&CF” or “Preference-based CF”, and “DPO+CCF” or “Preference-based CCF”).

In the example, the results shown in FIG. 8B and FIG. 8C show the sufficiency inconsistency rate (S-IR) in relation to the factual/counterfactual error rates (F-ER, CF-ER) across all approaches. In this example, when evaluating models, 10 answers were sampled for each question, which gives a distribution over ER/IR (rather than just a point estimation). SFT and DPO models, trained exclusively on either factual or counterfactual examples (SFT-OnlyF, SFT-OnlyCF, DPO-OnlyF, and DPO-OnlyCF) do not improve S-IR, even though they manage to reduce the corresponding F-ER/CF-ER. However, when given access to both types of examples, DPO-F&CF shows an improvement in S-IR, though this improvement is not as pronounced as the reduction observed in F-ER/CF-ER, particularly in CF-ER. The SFT-F&CF model shows a significant enhancement in both S-IR and F-ER, but it fails to make progress in CF-ER. Finally, by directly addressing causal consistency, with S-IR factored into the reward during fine-tuning, the DPO+CCF model achieves substantial improvements across F-ER, CF-ER, and S-IR. These results highlight the crucial role of effectively coordinating factual and counterfactual feedback for advanced reasoning tasks.

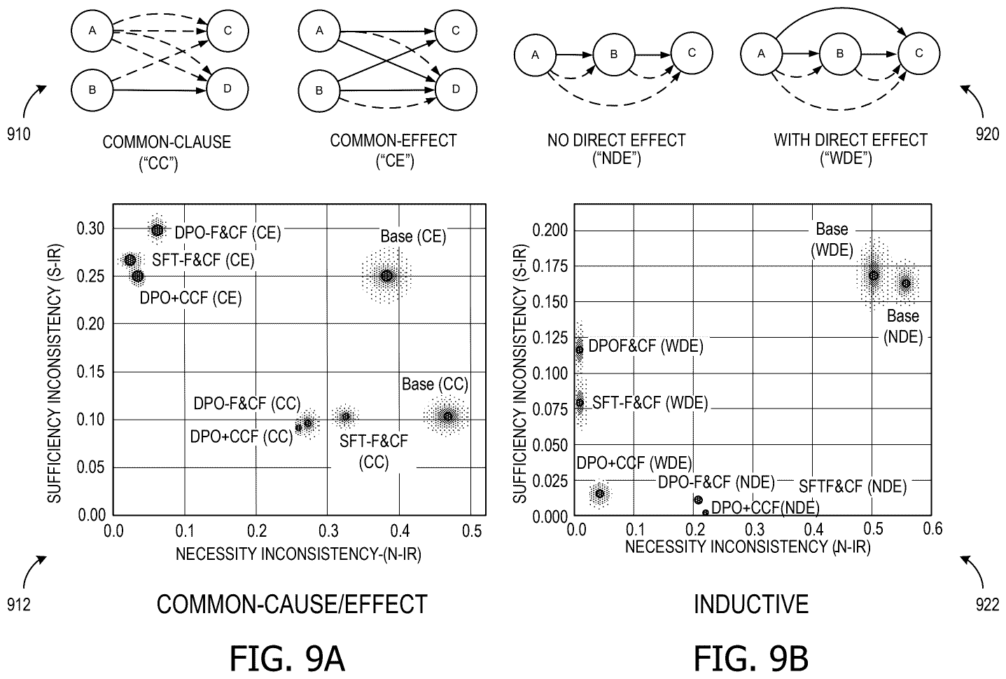

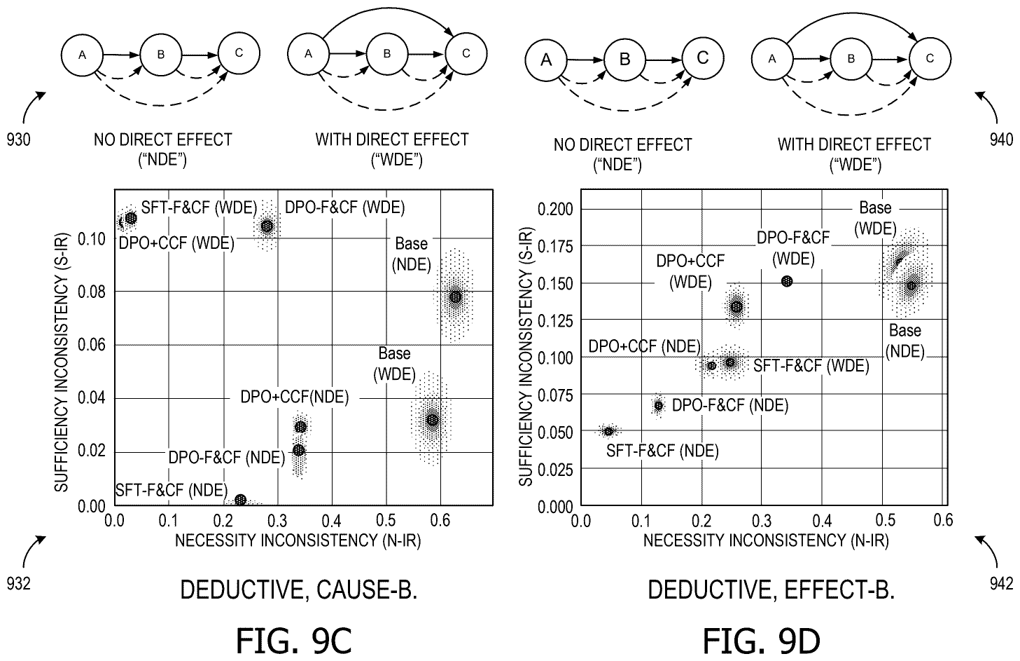

FIG. 9A to FIG. 9D illustrate example generalization results in the candy party puzzle described above. In the example, eight scenarios are considered involving three different causal structures: the bipartite graph {A,B}→{C,D} (discussed below as “Structure-1: Bipartite Graph”, as well as the chain A→B→C with and without a direct effect from A to C (discussed below as “Structure 2: Chain with No Direct Effect (NDE)” and “Structure-3: Chain With Direct Effect (WDE)”). In graphs 910, 920, 930, 940, broken arrows show the cause-effect interventions demonstrated to the model during fine-tuning and evaluation phases. In plots 912, 922, 932, 942, the causal reasoning ability of the fine-tuned models generalizes most effectively in inductive demonstrations, however, with common-cause/effect and deductive demonstrations, they no longer show the same reasoning improvements as observed in the in-domain setting.

More specifically, this example and results shown in FIG. 9A to FIG. 9D addresses to what extent the performance improvements in causal reasoning achieved through the fine-tuning process generalize across all the generalization modes defined above. As discussed above, an in-domain evaluation alone is inadequate for fully assessing the success of fine-tuning for reasoning and differentiating it from basic recall. Therefore, all fine-tuning methods in the generalization modes discussed above are evaluated.

To allow for the example question 810 posed in FIG. 8A to reflect all possible generalization modes, slight modifications to the puzzle context were made, creating two variations: chain NDE and chain WDE (e.g., “Structure-2” and “Structure-3”). The graphs 810, 820, 830, 840 display all the causal structures used for each generalization mode, along with the cause-effect interventions demonstrated during the fine-tuning and evaluation phases.

Based on the findings from the in-domain reasoning experiments, where both SFT and DPO fine-tuning methods showed significantly better performance when provided with both factual and counterfactual examples, only the methods SFT-F&CF, DPO-F&CF, DPO+CCF, and the Base model are included here.

In the example, the plots 912, 922, 932, 942 present the causal reasoning performance of all systems across the different generalization modes. It is observed that: (i) For Common-Cause (CC)/Common-Effect (CE), as shown in plot 912, fine-tuning based on demonstrations that involve just the target cause or the target effect (but not both as in the in-domain case) no longer leads to improvements in S-IR (unlike the in-domain case). While improvements in N-IR are seen, this can be attributed to better recall and not necessarily to better reasoning. The common-effect case leads to the greater improvement in N-IR precisely because the task of identifying factuals remains the same in this mode of generalization. (ii) For Induction, as shown in plot 922, fine-tuning generalizes best when performed inductively. This is because relationships involving both the target cause and the target effect have been demonstrated, albeit not together. (iii) For Deductions, as shown in plots 932, 942, while harder than induction, deduction is also possible as long as there are no direct effects that circumvent the intermediate variable. If there are such effects, deduction based on a shared cause becomes virtually impossible. Without any intervention on the intermediate variable, it is challenging to tell how much of the shared cause's effect is mediated through the intermediate variable versus how much of it is not. Meanwhile, this seems to be identifiable to some extent when interventions on the intermediate variable are demonstrated as in deduction based on a shared effect.

In examples, when collecting datasets, 100 contexts were sampled and 10 answers were generated for each question per context. In order to obtain error bars, each experiment was repeated five times. The extractor h is implemented using Llama 3 8B with the following prompt:
I will give you a question and its answer. Determine whether the meaning of the answer is ‘POSITIVE’ or ‘NEGATIVE’. An answer is ‘POSITIVE’ if it contains phrases like ‘yes’, ‘it holds’, ‘correct’, ‘true’, or similar affirmations. An answer is ‘NEGATIVE’ if it contains phrases like ‘no’, ‘it does not hold’, ‘incorrect’, ‘false’, or similar negations. Respond only with one word: ‘POSITIVE’ or ‘NEGATIVE’. Question: ‘{q}’ Answer: ‘{a}’. Is the meaning ‘POSITIVE’ or ‘NEGATIVE’?

Similarly, the answer generator H, in the case of supervised counterfactual feedback (“Supervised CF”), is implemented using Llama 3 8B with the following prompt:
I will give you a question and the initial word of its answer. Complete the answer starting from the provided word. Respond only with the complete answer. Question: {q} Answer: {No/Yes}, . . .

In the above candy party example, this hand-crafted puzzle has been used in the experiments discussed above. Based on different generalization modes, three variations of this puzzle have been developed, each featuring distinct causal structures.

A first causal structure is introduced above as “Structure-1: Bipartite Graph.” For context in this first causal structure, Anna, Bill, Cory, and Dave are going to a party, where the host is going to distribute candies. Anna will be happy if she gets at least 4 candies. Bill will be happy if he gets at least 6 candies. Cory will be happy if Anna and Bill are both happy or if he gets at least 8 candies. Dave will be happy if Anna and Bill are both happy or if he gets at least 10 candies. After distributing the candies, Anna gets {N_{A}}, Bill gets {N_{B}}, Cory gets {N_{C}}, and Dave gets {N_{D}}. The factual question (e.g., LLM prompt) is: “Is {Anna/Bill/Cory/Dave} happy? Be as concise as possible.” The intervention question (e.g., LLM prompt) is: “Now, suppose that {Anna/Bill/Cory/Dave} {is/is not} happy regardless of the candy distribution. With this assumption, is {Anna/Bill/Cory/Dave} happy? Be as concise as possible.” Under this causal structure, the causal relationships are: A=N_{A}≥4; B=N_{B}≥6; C=(A∧B)∨(N_{C}≥8); and D=(A∧B)∨(N_{D}≥10). This first causal structure is demonstrated by the nodes and solid lines of graph 910.

A second causal structure is introduced above as “Structure-2: Chain with No Direct Effect (NDE).” For context in this second causal structure, Anna, Bill, and Cory are going to a party, where the host is going to distribute candies. Anna will be happy if she gets at least 5 candies. Bill will be happy if Anna is happy or if he gets at least 7 candies. Cory will be happy if Bill is happy or if he gets at least 9 candies. After distributing the candies, Anna gets {N_{A}}, Bill gets {N_{B}}, and Cory gets {N_{C}}. The factual question (e.g., LLM prompt) is: “Is {Anna/Bill/Cory} happy? Be as concise as possible.” The intervention question (e.g., LLM prompt) is: “Now, suppose that {Anna/Bill/Cory} {is/is not} happy regardless of the candy distribution. With this assumption, is {Anna/Bill/Cory} happy? Be as concise as possible.” Under this causal structure, the causal relationships are: A=N_{A}≥5; B=A∨(N_{B}≥7); and C=B∨(N_{C}≥9). This second causal structure is demonstrated by the nodes and solid lines in the NDE portions of graphs 920, 930, and 940.

A third causal structure is introduced above as “Structure-3: Chain With Direct Effect (WDE).” For context in this third causal structure, Anna, Bill, and Cory are going to a party, where the host is going to distribute candies. Anna will be happy if she gets at least 5 candies. Bill will be happy if Anna is happy or if he gets at least 7 candies. Cory will be happy if Anna and Bill are both happy or if he gets at least 9 candies. After distributing the candies, Anna gets {N_{A}}, Bill gets {N_{B}}, and Cory gets {N_{C}}. The factual question (e.g., LLM prompt) is: “Is {Anna/Bill/Cory} happy? Be as concise as possible.” The intervention question (e.g., LLM prompt) is: “Now, suppose that {Anna/Bill/Cory} {is/is not} happy regardless of the candy distribution. With this assumption, is {Anna/Bill/Cory} happy? Be as concise as possible.” Under this causal structure, the causal relationships are: A=N_{A}≥5; B=A∨(N_{B}≥7); and C=(A∧B)∨(N_{C}≥9). This third causal structure is demonstrated by the nodes and solid lines in the WDE portions of graphs 920, 930, and 940.

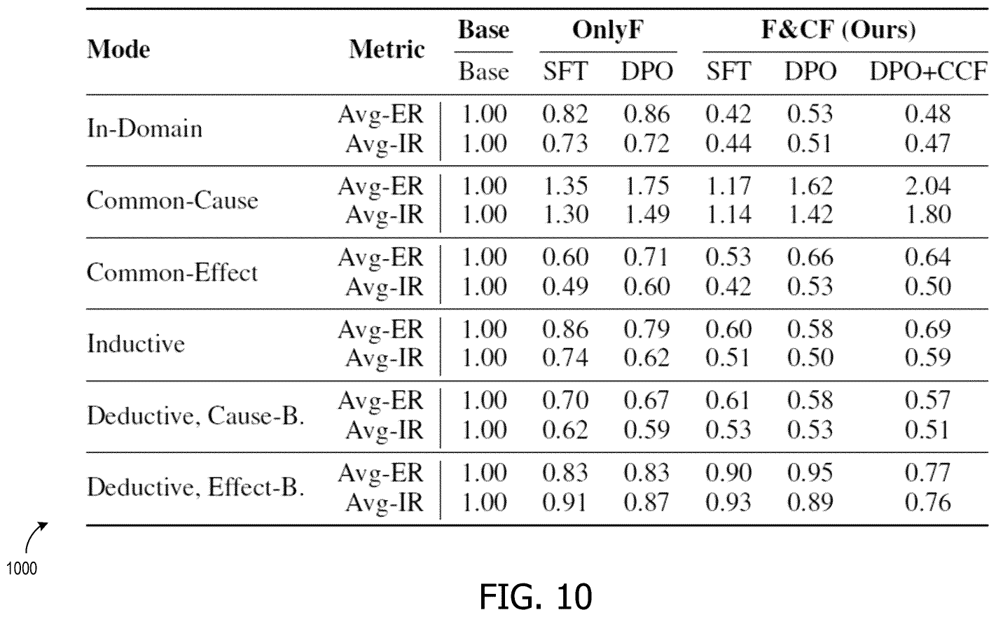

FIG. 10 is a table 1000 that illustrates average generalization performance across three real-world causal computational reasoning problems. In the example, the scores provided in the table 1000 are normalized relative to the Base approach's scores in each generalization mode. Higher scores indicate a greater number of errors made by the approach, with scores above 10. meaning that the approach makes more mistakes than the Base model, which has not undergone any fine-tuning.

In the example, the experimental findings are validated in real-world problems from three domains. First, in the Healthcare domain, breast cancer treatment is examined, and a simplified problem is developed that determines how different treatment options (e.g., radiotherapy/chemotherapy and surgery) are assigned to patients based on cancer type, tumor size, and nodal involvement. This model is grounded in real-world guideline (MD Anderson Cancer Center) and published statistics on the disease (Orrantia-Borunda et al., 2022; Sezgun et al., 1120; Carey et al., 2006). Next, in the Engineering domain, an automatic fault detection algorithm for transmission lines is implemented. This algorithm aims to identify the type of fault occurring on a transmission line using three different measurements. As the third, in the Math Benchmarking domain, a math question from GSM8K is selected (a widely used benchmark for evaluating language models on grade school math problems). A detailed examination of these three problems, including the context, factual and counterfactual questions, causal structures, and the cause-effect interventions demonstrated during the fine-tuning and evaluation phases across different generalization modes is presented below.

Regarding the Healthcare problem, consider the following context: There are four types of breast cancer patients (based on their ERPR and HER2 indicators): (1) If a patient is ERPR positive and HER2 negative, they are ‘Luminal A’. All luminal A patients should undergo surgery. (2) If a patient is ERPR positive and HER2 positive, they are ‘Luminal B’. Luminal B patients should undergo surgery if their tumor is smaller than 1 centimeter (cm) and there is no nodal involvement. Luminal B patients should undergo therapy if their tumor is larger than 1 cm or if there is nodal involvement. (3) if a patient is ERPR negative and HER2 positive, they are ‘Enriched’. Enriched patients should undergo surgery if their tumor is smaller than 1 cm and there is no nodal involvement. Enriched patients should undergo therapy only if their tumor is larger than 1 cm (even if there is nodal involvement). (4) If a patient is ERPR negative and HER2 negative, they are ‘Basal’. Basal patients should undergo surgery if their tumor is smaller than 1 cm and there is no nodal involvement. Basal patients should undergo therapy only if their tumor is larger than 1 cm (even if there is nodal involvement). Jane is ERPR {negative/positive} and HER2 {negative/positive}. Her tumor is {Tem} cm and there is {nodal involvement/no nodal involvement}. The factual question (e.g., of the LLM prompt) is “Will she undergo {surgery/therapy}? Be as concise as possible.” Possible interventional questions are: “If {Jane had been ERPR positive/Jane had been ERPR negative/Jane had been HER2 positive/Jane had been HER2 negative/the tumor had been larger than 1 cm/the tumor had been smaller than 1 cm/there had been nodal involvement/there had been no nodal involvement}, should she have undergone {surgery/therapy}? Be as concise as possible.”

The causal relationships for the Healthcare problem include:

$$\begin{matrix}{H}_{ERPR} , {H}_{HER 2} \sim \{ \begin{matrix}\begin{matrix}( 1 , 0 ) & with probability 0.5\end{matrix} \\ \begin{matrix}( 1 , 1 ) & with probability 0.15\end{matrix} \\ \begin{matrix}( 0 , 1 ) & with probability 0.2\end{matrix} \\ \begin{matrix}( 0 , 0 ) & with probability 0.15\end{matrix}\end{matrix} \\ {C}_{type} \sim \{ \begin{matrix}\begin{matrix}Luminal A & if {H}_{ERPR}\end{matrix} ∧ ¬ {H}_{HER 2} \\ \begin{matrix}Luminal B & if {H}_{ERPR}\end{matrix} ∧ {H}_{HER 2} \\ \begin{matrix}Enriched & if ¬ {H}_{ERPR}\end{matrix} ∧ {H}_{HER 2} \\ \begin{matrix}Basal & if ¬ {H}_{ERPR}\end{matrix} ∧ ¬ {H}_{HER 2}\end{matrix} \\ {T}_{cm} \sim \{ \begin{matrix}𝒩 ( μ = 3.07 , σ = 2.22 if Luminal A \\ 𝒩 ( μ = 2.96 , σ = 1.45 if Luminal B \\ 𝒩 ( μ = 2.42 , σ = 1.03 if Enriched \\ 𝒩 ( μ = 3.32 , σ = 3.64 if Basal\end{matrix} \\ T = ( {T}_{cm} \geq 1 ) \\ 𝒩 \sim \{ \begin{matrix}ℬ ( p = 86 / 251 ) if Luminal A \\ ℬ ( p = 35 / 79 ) if Luminal B \\ ℬ ( p = 18 / 32 ) if Enriched \\ ℬ ( p = 41 / 99 ) if Basal\end{matrix} \\ {Y}_{surgery} = \{ \begin{matrix}1 if Luminal A \\ ¬ T ∧ ¬ N if Luminal B \\ ¬ T ∧ ¬ N otherwise\end{matrix} \\ {Y}_{therapy} = \{ \begin{matrix}0 if Luminal A \\ T ∨ N if Luminal B \\ T otherwise\end{matrix}\end{matrix}$$

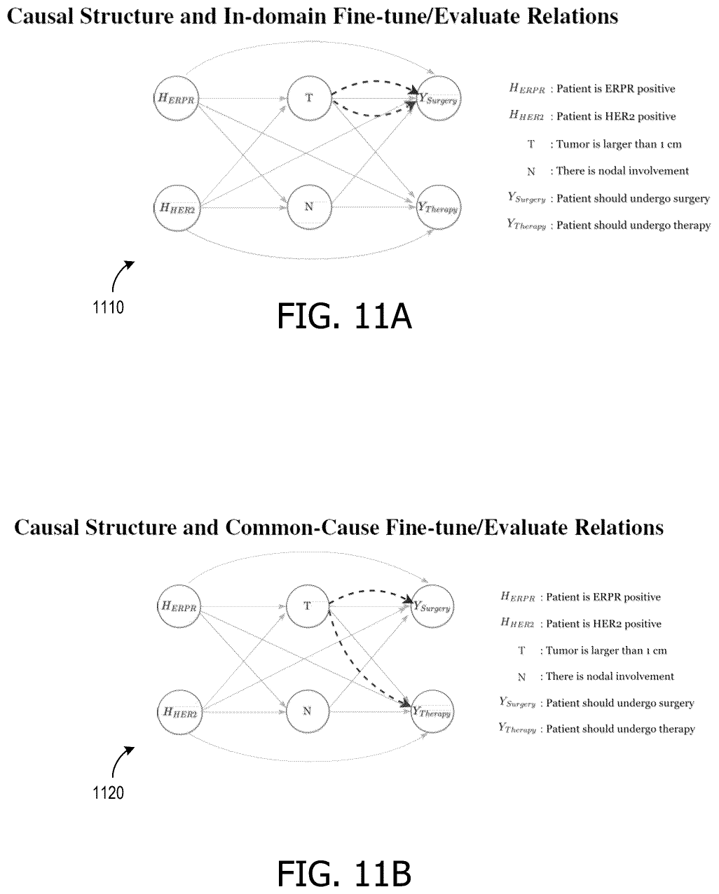

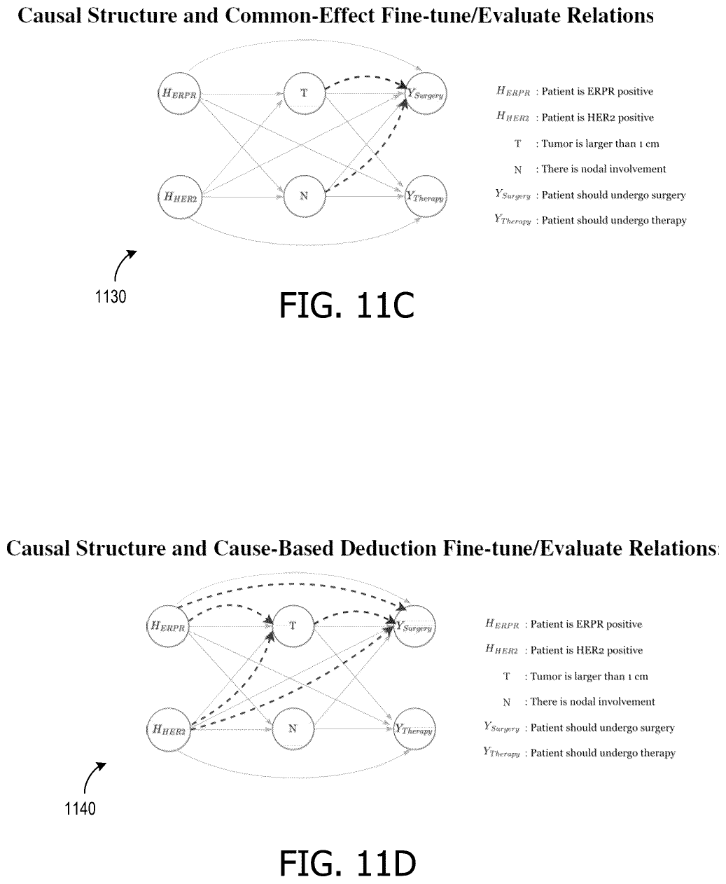

FIG. 11A to FIG. 11D include graphs 1110, 1120, 1130, 1140 that illustrate the causal structure and fine-tuning/evaluation relations for the Healthcare problem.

Regarding the Engineering problem, and referring again to FIG. 10, consider the following context: “The type of fault on a transmission line is determined through three factors X, Y, and Z. These factors are ‘close to zero’ if they are less than 0.1. (1) If only one of the factors is close to zero, it is a line-to-line fault. When there is a line-to-line fault, it is BC fault if factor X is close to zero, AC fault if factor Y is close to zero, and AB fault if factor Z is close to zero. (2) If exactly two of the factors are close to zero, it is a line-to-ground fault. When there is a line-to-ground fault, it is AG fault if factors Y and Z are both close to zero, BG fault if factors X and Z are both close to zero, and CG fault if factors X and Y are both close to zero. For some faulty transmission line, X=X, Y=Y, and Z=Z.” The factual question (e.g., of the LLM prompt) is “{Is there a line-to-line/line-to-ground fault?/Is the fault type BC/AC/AB/AG/BG/CG?} Be as concise as possible.” Possible interventional questions are: “If factor X/Y/Z had been/had not been close to zero, {would there have been a line-to-line/line-to-ground fault?/would the fault have been type BC/AC/AB/AG/BG/CG}? Be as concise as possible.”

The causal relationships for the Engineering problem include:

$$\begin{matrix}X \sim 𝒩 ( μ = \overline{X} , σ = 0.1 ) \\ Y \sim 𝒩 ( μ = \overline{Y} , σ = 0.1 ) \\ Z \sim 𝒩 ( μ = \overline{Z} , σ = 0.1 ) \\ {X}_{0} = ( X < 0.1 ) \\ {Y}_{0} = ( Y < 0.1 ) \\ {Z}_{0} = ( Z < 0.1 ) \\ LL = ( {X}_{0} ∧ ¬ {Y}_{0} ∧ ¬ {Z}_{0} ) ∨ ( ¬ {X}_{0} ∧ {Y}_{0} ∧ ¬ {Z}_{0} ) ∨ ( ¬ {X}_{0} ∧ ¬ {Y}_{0} ∧ {Z}_{0} )\end{matrix}$$

$$LG = ( ¬ {X}_{0} ∧ {Y}_{0} ∧ {Z}_{0} ) ∨ ( {X}_{0} ∧ ¬ {Y}_{0} ∧ {Z}_{0} ) ∨ ( {X}_{0} ∧ {Y}_{0} ∧ ¬ {Z}_{0} ) ∨ ( {X}_{0} ∧ {Y}_{0} ∧ {Z}_{0} )$$

$$\begin{matrix}BC = LL ∧ {X}_{0} \\ AC = LL ∧ {Y}_{0} \\ AB = LL ∧ {Z}_{0} \\ AG = LG ∧ {Y}_{0} ∧ {Z}_{0} \\ BG = LG ∧ {X}_{0} ∧ {Z}_{0} \\ CG = LG ∧ {X}_{0} ∧ {Y}_{0}\end{matrix}$$

where X̅, Y̅, and Z̅ are drawn randomly from the values reported in the supporting data.

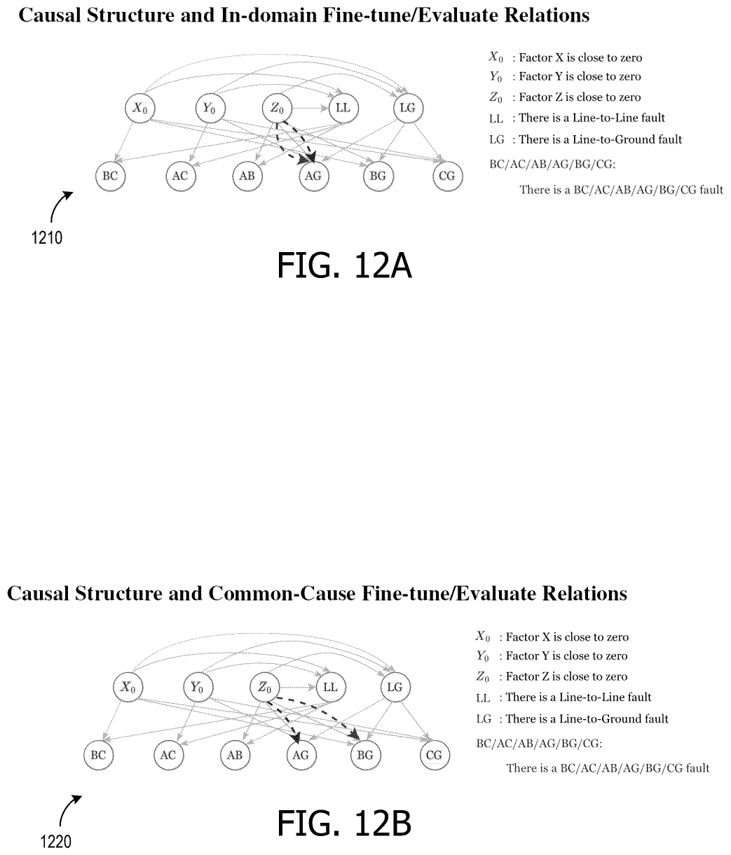

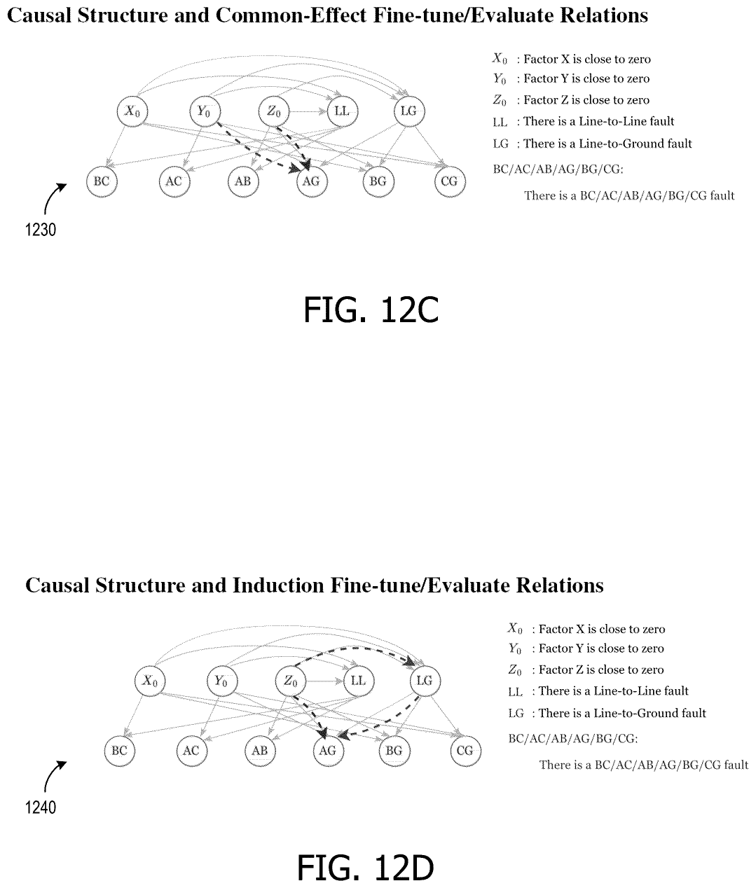

FIG. 12A to FIG. 12D include graphs 1210, 1820, 1830, 1240 that illustrate the causal structure and fine-tuning/evaluation relations for the Engineering problem.

Regarding the Math Benchmarking problem, and referring again to FIG. 10, consider the following context: “Carla is downloading a {N_{size}} GB file. Normally she can download 2 GB/minute, but in 100 minutes, Windows will force a restart to install updates, which takes {Nₘᵢₙᵤₜₑₛ} minutes. After the restart, Carla can resume her download.” The factual question (e.g., of the LLM prompt) is “{Will Windows force a restart before the download is complete?/Will the download take longer than 120 minutes?} Be as concise as possible.” Possible interventional questions are: “If {she were downloading a file twice the size/Windows had forced a restart before the download was complete/Windows had not forced a restart before the download was complete}, would {Windows have forced a restart before the download was complete?/the download have taken longer than 120 minutes?} Be as concise as possible.”

The causal relationships for the Math Benchmarking problem include:

$$\begin{matrix}{N}_{size} \sim 𝒰 ( 50 , 300 ) \\ {N}_{minutes} \sim 𝒰 ( 10 , 30 ) \\ S \sim ℬ ( p = 0.5 ) \\ {N}_{download \_ time} = [ {N}_{size} * 2 * S + {N}_{size} ( 1 - S ) ] / 2 \\ R = ( {N}_{download \_ time} \geq 100 ) \\ T = ( {N}_{download \_ time} + R * {N}_{minutes} \geq 120 )\end{matrix}$$

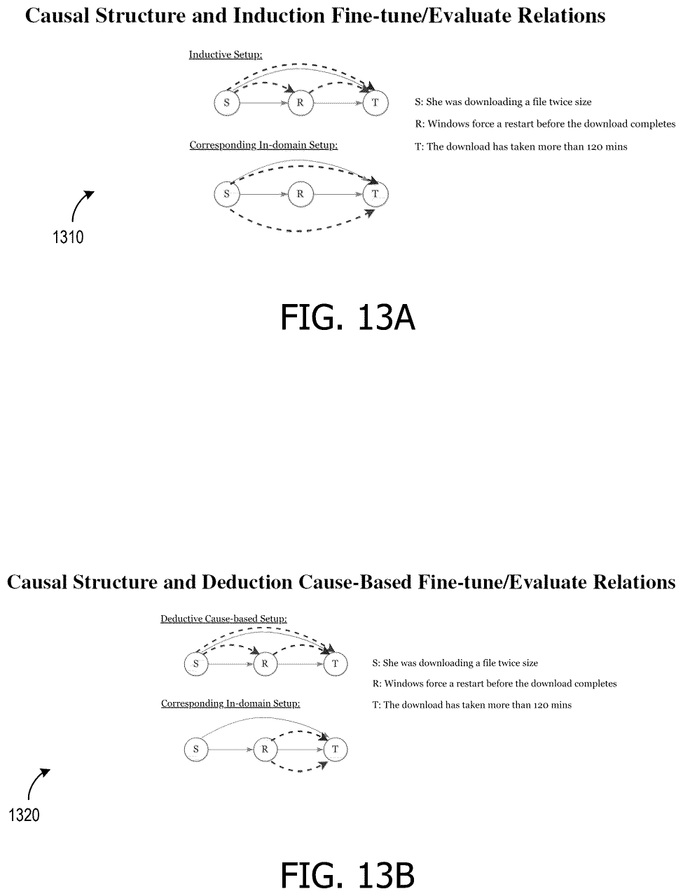

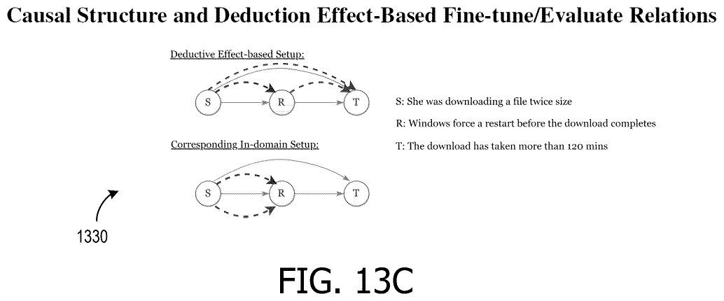

FIG. 13A to FIG. 13C include graphs 1310, 1320, 1330 that illustrate the causal structure and fine-tuning/evaluation relations for the Math Benchmarking problem.

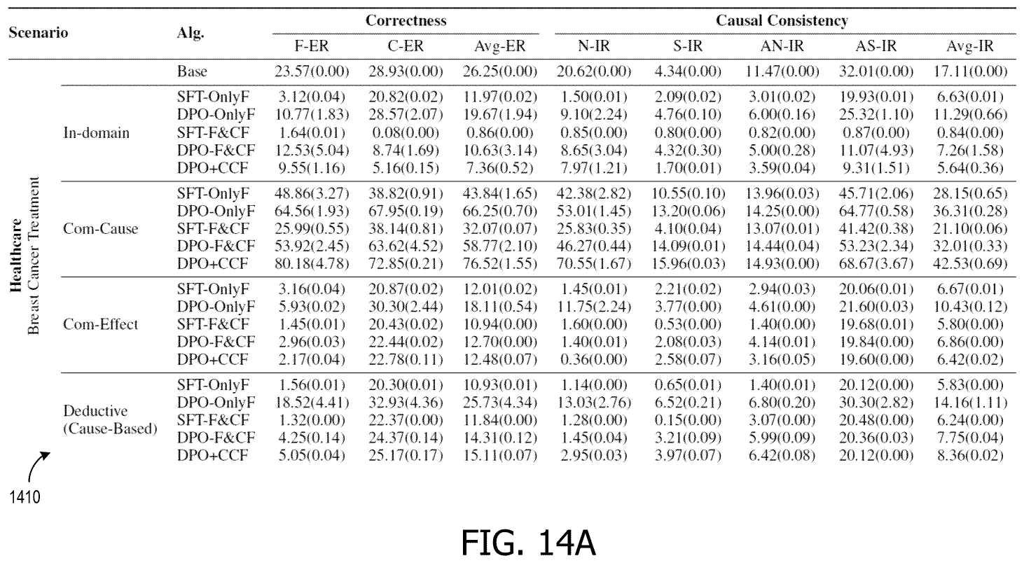

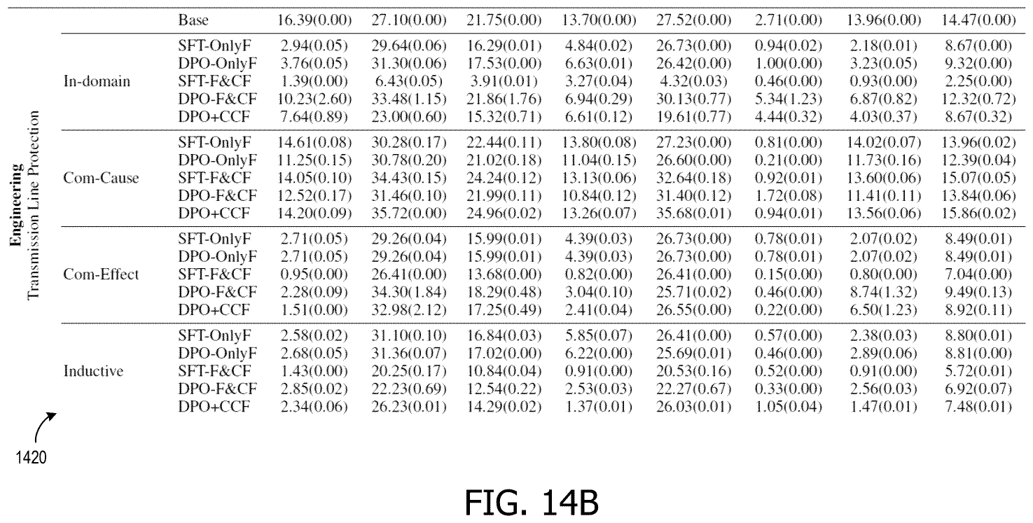

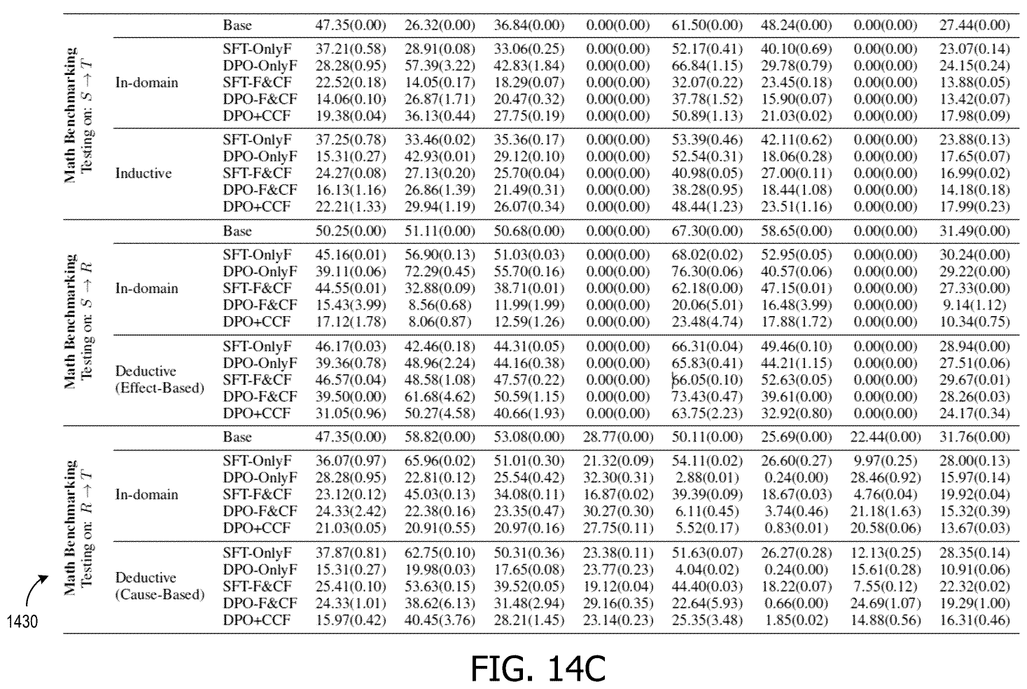

FIG. 14A, FIG. 14B, and FIG. 14C show the results of the three problems presented above. More specifically, FIG. 14A includes a table 1410 that shows the results of the Healthcare problem, FIG. 14B includes a table 1420 that shows the results of the Engineering problem, and FIG. 14C includes a table 1430 that shows the results of the Math Benchmarking problem. For some scenarios in Math Benchmarking, N-IR and S-IR are equal to 0.00 for all algorithms because the target cause X is never present without an intervention due to how these scenarios are structured.

In the example, the results for all three problems across in-domain and different generalization modes are shown in FIG. 14A to FIG. 14C. Given the extensive number of experiments in this table, the Average Error Rate (Avg-ER) and Average Inconsistency Rate (Avg-IR) scores are summarized in FIG. 10. For this summary, the scores of each approach are first normalized relative to the scores of the corresponding Base approach. Then, for each generalization mode (including the in-domain scenario), the average score of each tested method is calculated across all applicable problems. Note that not all generalization modes were tested for every problem due to differences in causal structures, so the average scores were calculated using only the problems that were tested for each generalization mode. In FIG. 10, higher scores indicate more errors, and scores above 1.0 signify that the approach makes more mistakes than the Base model. It is observed that: (i) In the in-domain scenario, when the fine-tuning is guided by both factual and counterfactual examples (*-F&CF), the language models show a significant improvement in causal computational reasoning performance. (ii) Similar to what was observed in previous experiments, this improvement generalizes to most generalization modes, with the exception of common-cause and effect-based deduction. (iii) In most modes, language models trained with causal consistency feedback (e.g., DPO+CCF) demonstrate a lower error and inconsistency rate.

### Example Algorithms

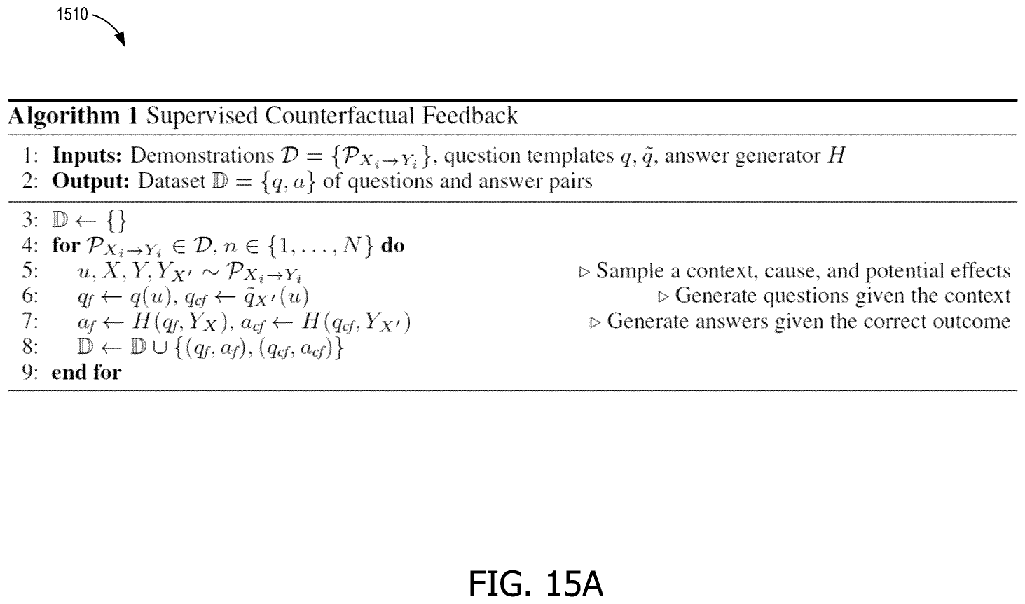

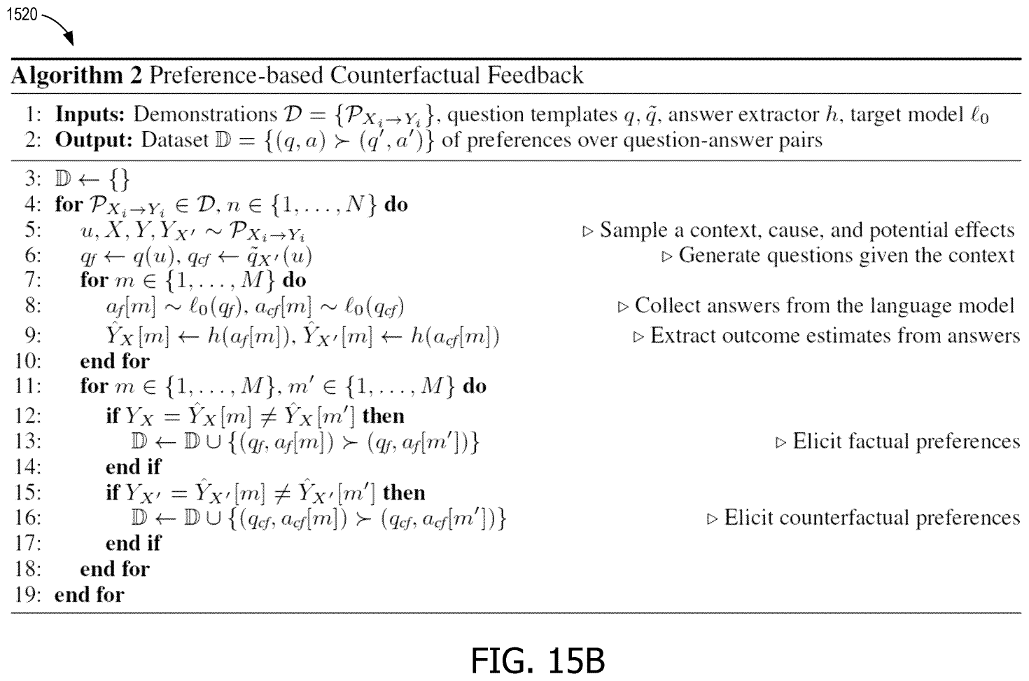

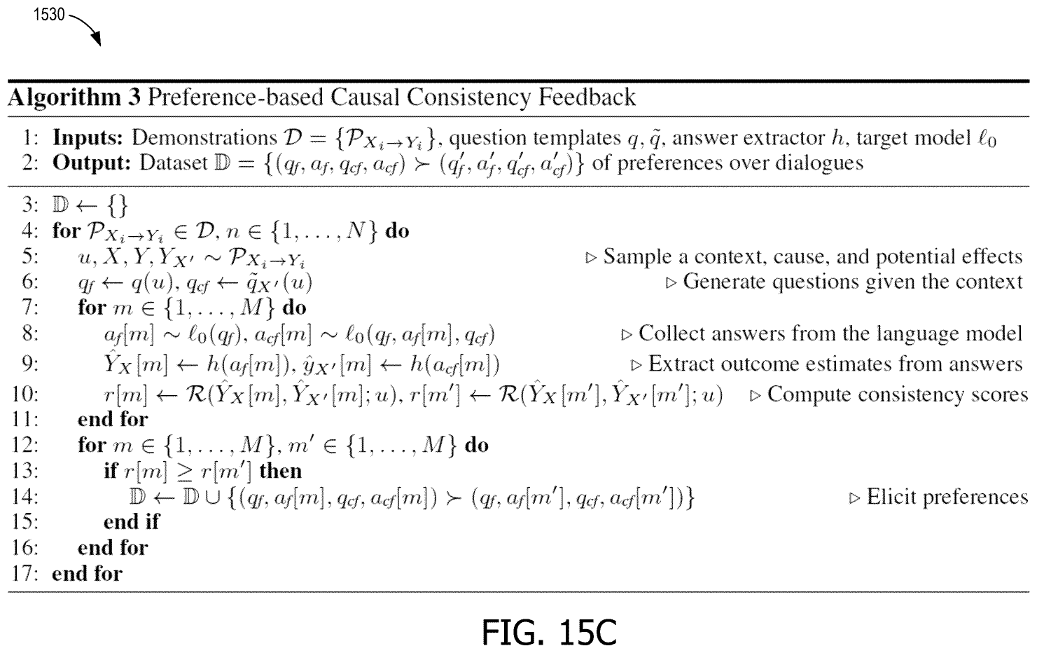

FIG. 15A, FIG. 15B, and FIG. 15C present example algorithms 1510, 1520, 1530 and associated pseudo-code for generating datasets D for the fine-tuning methods shown in FIG. 5A, FIG. 6A, and FIG. 7A, respectively. More specifically, the algorithm 1510 shown in FIG. 15A is used to generate fine-tuning dataset 232A for Supervised CF (e.g., as shown and discussed in FIG. 5A). The algorithm 1520 shown in FIG. 15B is used to generate fine-tuning dataset 232B for Preference-based CF (e.g., as shown and discussed in FIG. 6A). The algorithm 1530 shown in FIG. 15C is used to generate fine-tuning dataset 232C for Preference-based CCF (e.g., as shown and discussed in FIG. 7A).

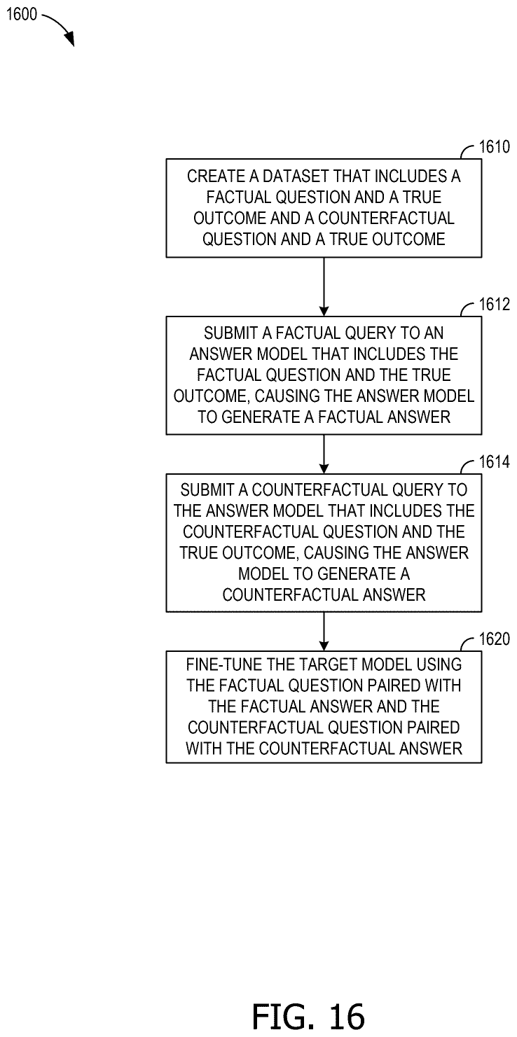

FIG. 16 is a flowchart 1600 of an example process for fine-tuning GAI models such as the target model 204A of FIG. 5A. In examples, the process is performed by the MT device 210 while fine-tuning the target model 204A shown in FIG. 5A. In the example, at operation 1610, the MT device 210 creates a dataset (e.g., starting inputs 230A) that includes a plurality of paired samples (e.g., F/CF question pair 510), each paired sample of the plurality of paired samples includes (i) a factual question (e.g., factual question 512) and a true outcome for that factual question (e.g., true outcome 514) and (ii) a counterfactual question (e.g., counterfactual question 516) and a true outcome for that counterfactual question (e.g., true outcome 518). In some examples, the counterfactual question is a reformulation of the factual question where one or more premises and assumptions included in the factual question are altered in the counterfactual question such as to contradict the factual question.

At operation 1612, in the example, the MT device 210 submits a factual query (e.g., query 522A) to an answer model (e.g., answer model 520), the factual query including the factual question and the true outcome of the factual question, the answer model generating a factual answer (e.g., answer 524A) in response to the factual query. At operation 1614, the MT device 210 submits a counterfactual query (e.g., query 522B) to the answer model, the counterfactual query including the counterfactual question and the true outcome of the counterfactual question, the answer model generating a counterfactual answer (e.g., answer 524B) in response to the counterfactual query. In some examples, the factual answer includes the true outcome of the factual question, and the counterfactual answer includes the true outcome of the counterfactual question.

At operation 1620, in the example, the MT device 210 performs fine-tuning (e.g., supervised fine-tuning 250A) on a target model (e.g., target model 204A) using at least the factual question paired with the factual answer and the counterfactual question paired with the counterfactual answer. In some examples, performing fine-tuning on the target model further includes performing supervised fine-tuning on the target model, wherein the factual question and the factual answer represent a first input-output pair and the counterfactual question and the counterfactual answer represent a second input-output pair (e.g., fine-tuning pairs 530).

In some examples, the MT device 210 also generates the factual query by concatenating the factual question with the true outcome of the factual question, thereby causing the true outcome of the factual question to appear at the end of the factual query, and generates the counterfactual query by concatenating the counterfactual question with the true outcome of the counterfactual question, thereby causing the true outcome of the counterfactual question to appear at the end of the counterfactual query.

In some examples, the MT device 210 also generates the factual question using a factual question template and inserting a first parameter into the factual question template, and generates the counterfactual question using a counterfactual question template and inserting said first parameter into the counterfactual question template.

In some examples, the answer model is a language model configured to generate outputs in a natural language, and the factual answer and the counterfactual answer are in the natural language, and the factual answer begins with the true outcome of the factual question, and the counterfactual answer begins with the true outcome of the counterfactual question.

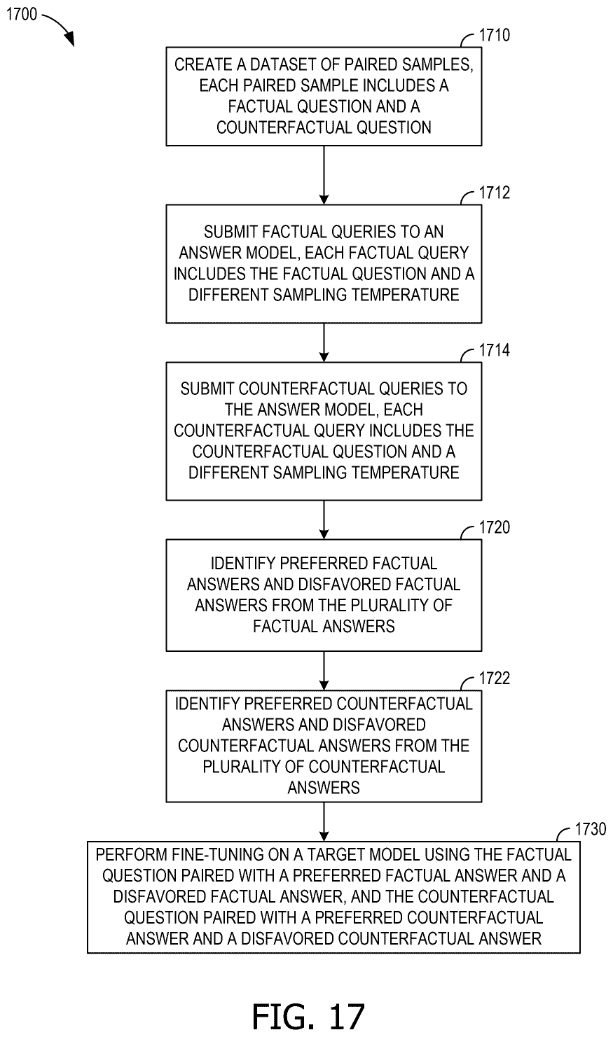

FIG. 17 is a flowchart 1700 of an example process for fine-tuning GAI models such as the target model 204A of FIG. 6A. In examples, the process is performed by the MT device 210 while fine-tuning the target model 204A shown in FIG. 6A. In the example, at operation 1710, the MT device 210 creates a dataset (e.g., starting inputs 230B) that includes a plurality of paired samples (e.g., F/CF question pairs 610), each paired sample of the plurality of paired samples includes a factual question (e.g., factual question 512) and a counterfactual question (e.g., counterfactual question 516). In some examples, the counterfactual question is a reformulation of the factual question where one or more premises and assumptions included in the factual question are altered in the counterfactual question such as to contradict the factual question.

At operation 1712, in the example, the MT device 210 submits a plurality of factual queries (e.g., queries 622A) to an answer model (e.g., target model 204A), each factual query of the plurality of factual queries including the factual question and a different sampling temperature, thereby causing the answer model to vary randomness of output, the answer model generating a plurality of factual answers (e.g., answers 624A of answer set 626A) in response to the plurality of factual queries. At operation 1714, the MT device 210 submits a plurality of counterfactual queries (e.g., queries 622B) to the answer model, each counterfactual query of the plurality of counterfactual queries including the counterfactual question and a different sampling temperature, thereby causing the answer model to vary randomness of output, the answer model generating a plurality of counterfactual answers (e.g., answers 624B of answer set 626B) in response to the plurality of counterfactual queries.

At operation 1720, in the example, the MT device 210 identifies one or more preferred factual answers (e.g., preferred answer 632A) from the plurality of factual answers, the remaining factual answers of the plurality of factual answers being one or more disfavored factual answers (e.g., disfavored answer 634A). At operation 1722, the MT device 210 identifies one or more preferred counterfactual answers (e.g., preferred answer 632B) from the plurality of counterfactual answers, the remaining counterfactual answers of the plurality of counterfactual answers being one or more disfavored counterfactual answers (e.g., disfavored answer 634B).

At operation 1730, in the example, the MT device 210 performs fine-tuning (e.g., preference-based fine-tuning 250B) on a target model (e.g., target model 204A) using at least (i) the factual question paired with the one or more preferred factual answers and the one or more disfavored factual answers and (ii) the counterfactual question paired with the one or more preferred counterfactual answers and the one or more disfavored counterfactual answers. In some examples, performing fine-tuning on the target model further includes performing preference-based fine-tuning on the target model using Direct Policy Optimization. In some examples, the MT device 210 also identifies a first triplet that includes the factual question, a first preferred factual answer of the one or more preferred factual answers, a first disfavored factual answer of the one or more disfavored factual answers, and first preference data representing preference for the first preferred factual answer over the first disfavored factual answer, and identifies a second triplet that includes the counterfactual question, a first preferred counterfactual answer of the one or more preferred counterfactual answers, a first disfavored counterfactual answer of the one or more disfavored counterfactual answers, and second preference data representing preference for the first preferred counterfactual answer over the first disfavored counterfactual answer, and fine-tunes the target model via preference-based fine-tuning using at least the first triplet and the second triplet.

In some examples, the MT device 210 also generates the factual question using a factual question template and inserting a first parameter into the factual question template, and generates the counterfactual question using a counterfactual question template and inserting said first parameter into the counterfactual question template. In some examples, the answer model is the target model.

### ADDITIONAL EXAMPLES

An example computerized method for fine-tuning a language model comprises: creating a dataset that includes a plurality of paired samples, each paired sample of the plurality of paired samples includes (i) a factual question and a true outcome for that factual question and (ii) a counterfactual question and a true outcome for that counterfactual question; submitting a factual query to an answer model, the factual query including the factual question and the true outcome of the factual question, the answer model generating a factual answer in response to the factual query; submitting a counterfactual query to the answer model, the counterfactual query including the counterfactual question and the true outcome of the counterfactual question, the answer model generating a counterfactual answer in response to the counterfactual query; and performing fine-tuning on a target model using at least the factual question paired with the factual answer and the counterfactual question paired with the counterfactual answer.

An example system for fine-tuning generative artificial intelligence (GAI) models comprises: a processor; and a memory comprising computer-readable instructions, the processor, the memory and the computer-readable instructions configured to cause the processor to: create a dataset that includes a plurality of paired samples, each paired sample of the plurality of paired samples includes (i) a factual question and a true outcome for that factual question and (ii) a counterfactual question and a true outcome for that counterfactual question; submit a factual query to an answer model, the factual query including the factual question and the true outcome of the factual question, the answer model generating a factual answer in response to the factual query; submit a counterfactual query to the answer model, the counterfactual query including the counterfactual question and the true outcome of the counterfactual question, the answer model generating a counterfactual answer in response to the counterfactual query; and perform fine-tuning on a target model using at least the factual question paired with the factual answer and the counterfactual query paired with the counterfactual answer.

An example computer storage medium having computer-executable instructions that, upon execution by a processor of a computer, cause the processor to at least: create a dataset that includes a plurality of paired samples, each paired sample of the plurality of paired samples includes (i) a factual question and a true outcome for that factual question and (ii) a counterfactual question and a true outcome for that counterfactual question; submit a factual query to an answer model, the factual query including the factual question and the true outcome of the factual question, the answer model generating a factual answer in response to the factual query; submit a counterfactual query to the answer model, the counterfactual query including the counterfactual question and the true outcome of the counterfactual question, the answer model generating a counterfactual answer in response to the counterfactual query; and perform fine-tuning on a target model using at least the factual question paired with the factual answer and the counterfactual query paired with the counterfactual answer.

An example computerized method for fine-tuning a language model comprises: creating a dataset that includes a plurality of paired samples, each paired sample of the plurality of paired samples includes a factual question and a counterfactual question; submitting a plurality of factual queries to an answer model, each factual query of the plurality of factual queries including the factual question and a different sampling temperature, thereby causing the answer model to vary randomness of output, the answer model generating a plurality of factual answers in response to the plurality of factual queries; submitting a plurality of counterfactual queries to the answer model, each counterfactual query of the plurality of counterfactual queries including the counterfactual question and a different sampling temperature, thereby causing the answer model to vary randomness of output, the answer model generating a plurality of counterfactual answers in response to the plurality of counterfactual queries; identifying one or more preferred factual answers from the plurality of factual answers, the remaining factual answers of the plurality of factual answers being one or more disfavored factual answers; identifying one or more preferred counterfactual answers from the plurality of counterfactual answers, the remaining counterfactual answers of the plurality of counterfactual answers being one or more disfavored counterfactual answers; and performing fine-tuning on a target model using at least (i) the factual question paired with the one or more preferred factual answers and the one or more disfavored factual answers and (ii) the counterfactual question paired with the one or more preferred counterfactual answers and the one or more disfavored counterfactual answers.

An example system for fine-tuning generative artificial intelligence (GAI) models comprising: a processor; and a memory comprising computer-readable instructions, the processor, the memory and the computer-readable instructions configured to cause the processor to: create a dataset that includes a plurality of paired samples, each paired sample of the plurality of paired samples includes a factual question and a counterfactual question; submit a plurality of factual queries to an answer model, each factual query of the plurality of factual queries including the factual question and a different sampling temperature, thereby causing the answer model to vary randomness of output, the answer model generating a plurality of factual answers in response to the plurality of factual queries; submit a plurality of counterfactual queries to the answer model, each counterfactual query of the plurality of counterfactual queries including the counterfactual question and a different sampling temperature, thereby causing the answer model to vary randomness of output, the answer model generating a plurality of counterfactual answers in response to the plurality of counterfactual queries; identify one or more preferred factual answers from the plurality of factual answers, the remaining factual answers of the plurality of factual answers being one or more disfavored factual answers; identify one or more preferred counterfactual answers from the plurality of counterfactual answers, the remaining counterfactual answers of the plurality of counterfactual answers being one or more disfavored counterfactual answers; and perform fine-tuning on a target model using at least (i) the factual question paired with the one or more preferred factual answers and the one or more disfavored factual answers and (ii) the counterfactual question paired with the one or more preferred counterfactual answers and the one or more disfavored counterfactual answers.

An example computer storage medium having computer-executable instructions that, upon execution by a processor of a computer, cause the processor to at least: create a dataset that includes a plurality of paired samples, each paired sample of the plurality of paired samples includes a factual question and a counterfactual question; submit a plurality of factual queries to a target model, each factual query of the plurality of factual queries including the factual question and a different sampling temperature, thereby causing the target model to vary randomness of output, the target model generating a plurality of factual answers in response to the plurality of factual queries; submit a plurality of counterfactual queries to the answer model, each counterfactual query of the plurality of counterfactual queries including the counterfactual question and a different sampling temperature, thereby causing the target model to vary randomness of output, the target model generating a plurality of counterfactual answers in response to the plurality of counterfactual queries; identify one or more preferred factual answers from the plurality of factual answers, the remaining factual answers of the plurality of factual answers being one or more disfavored factual answers; identify one or more preferred counterfactual answers from the plurality of counterfactual answers, the remaining counterfactual answers of the plurality of counterfactual answers being one or more disfavored counterfactual answers; and perform fine-tuning on the target model using at least (i) the factual question paired with the one or more preferred factual answers and the one or more disfavored factual answers and (ii) the counterfactual question paired with the one or more preferred counterfactual answers and the one or more disfavored counterfactual answers.

Alternatively, or in addition to the other examples described herein, examples include any combination of the following:
creating a dataset that includes a plurality of paired samples;
each paired sample of the plurality of paired samples includes (i) a factual question and a true outcome for that factual question and (ii) a counterfactual question and a true outcome for that counterfactual question;
submitting a factual query to an answer model;
the factual query including the factual question and the true outcome of the factual question;
the answer model generating a factual answer in response to the submitting of the factual query;
receiving a factual answer from the answer model in response to the factual query;
causing the answer model to generate a factual answer in response to the factual query;
submitting a counterfactual query to the answer model;
the counterfactual query including the counterfactual question and the true outcome of the counterfactual question;
the answer model generating a counterfactual answer in response to the counterfactual query;
causing the answer model to generate a counterfactual answer in response to the counterfactual query;
receiving a counterfactual answer from the answer model in response to the submitting of the counterfactual query;
performing fine-tuning on a target model using at least the factual question paired with the factual answer and the counterfactual question paired with the counterfactual answer;
submitting a cybersecurity query to the target model, the cybersecurity query including a security log from a computing device and a prompt instructing analysis of the security log to identify suspicious activity, causing the target model to generate an output identifying at least one anomalous event from the security log;
performing fine-tuning on the target model further includes performing supervised fine-tuning on the target model;
the factual question and the factual answer represent a first input-output pair and the counterfactual question and the counterfactual answer represent a second input-output pair;
generating the factual query by concatenating the factual question with the true outcome of the factual question, thereby causing the true outcome of the factual question to appear at the end of the factual query;
generating the counterfactual query by concatenating the counterfactual question with the true outcome of the counterfactual question, thereby causing the true outcome of the counterfactual question to appear at the end of the counterfactual query;
the factual answer includes the true outcome of the factual question;
the counterfactual answer includes the true outcome of the counterfactual question;
the counterfactual question is a reformulation of the factual question where one or more premises and assumptions included in the factual question are altered in the counterfactual question such as to contradict the factual question;
generating the factual question using a factual question template and inserting a first parameter into the factual question template;
generating the counterfactual question using a counterfactual question template and inserting said first parameter into the counterfactual question template;
the answer model is a language model configured to generate outputs in a natural language;
the factual answer and the counterfactual answer are in the natural language;
the factual answer begins with the true outcome of the factual question;
the counterfactual answer begins with the true outcome of the counterfactual question;
creating a dataset that includes a plurality of paired samples;
paired samples include a factual question and a counterfactual question;
submitting a plurality of factual queries to an answer model;
each factual query of the plurality of factual queries including the factual question and a different sampling temperature, thereby causing the answer model to vary randomness of output;
the answer model generating a plurality of factual answers in response to the plurality of factual queries;
causing the answer model to generate a plurality of factual answers in response to the plurality of factual queries;
submitting a plurality of counterfactual queries to the answer model;
each counterfactual query of the plurality of counterfactual queries including the counterfactual question and a different sampling temperature, thereby causing the answer model to vary randomness of output;
the answer model generating a plurality of counterfactual answers in response to the plurality of counterfactual queries;
causing the answer model to generate a plurality of counterfactual answers in response to the plurality of counterfactual queries;
identifying one or more preferred factual answers from the plurality of factual answers, the remaining factual answers of the plurality of factual answers being one or more disfavored factual answers;
selecting one or more preferred factual answers from the plurality of factual answers, at least one of the remaining factual answers of the plurality of factual answers being one or more disfavored factual answers;
selecting one or more factual answers from the plurality of factual answers, at least one of the remaining factual answers of the plurality of factual answers being one or more unselected factual answers;
identifying one or more preferred counterfactual answers from the plurality of counterfactual answers, the remaining counterfactual answers of the plurality of counterfactual answers being one or more disfavored counterfactual answers;
selecting one or more preferred counterfactual answers from the plurality of counterfactual answers, at least one of the remaining counterfactual answers of the plurality of counterfactual answers being one or more disfavored counterfactual answers;
selecting one or more counterfactual answers from the plurality of counterfactual answers, at least one of the remaining counterfactual answers of the plurality of counterfactual answers being one or more unselected counterfactual answers;
performing fine-tuning on a target model using at least (i) the factual question paired with the one or more preferred factual answers and the one or more disfavored factual answers and (ii) the counterfactual question paired with the one or more preferred counterfactual answers and the one or more disfavored counterfactual answers;
performing fine-tuning on the target model further includes performing preference-based fine-tuning on the target model using Direct Policy Optimization;
identifying a first triplet that includes the factual question, a first preferred factual answer of the one or more preferred factual answers, a first disfavored factual answer of the one or more disfavored factual answers, and first preference data representing preference for the first preferred factual answer over the first disfavored factual answer;
identifying a second triplet that includes the counterfactual question, a first preferred counterfactual answer of the one or more preferred counterfactual answers, a first disfavored counterfactual answer of the one or more disfavored counterfactual answers, and second preference data representing preference for the first preferred counterfactual answer over the first disfavored counterfactual answer;
fine-tuning the target model via preference-based fine-tuning using at least the first triplet and the second triplet; and
the answer model is the target model.

While the aspects of the disclosure have been described in terms of various examples with their associated operations, a person skilled in the art would appreciate that a combination of operations from any number of different examples is also within scope of the aspects of the disclosure.

### Exemplary Operating Environment

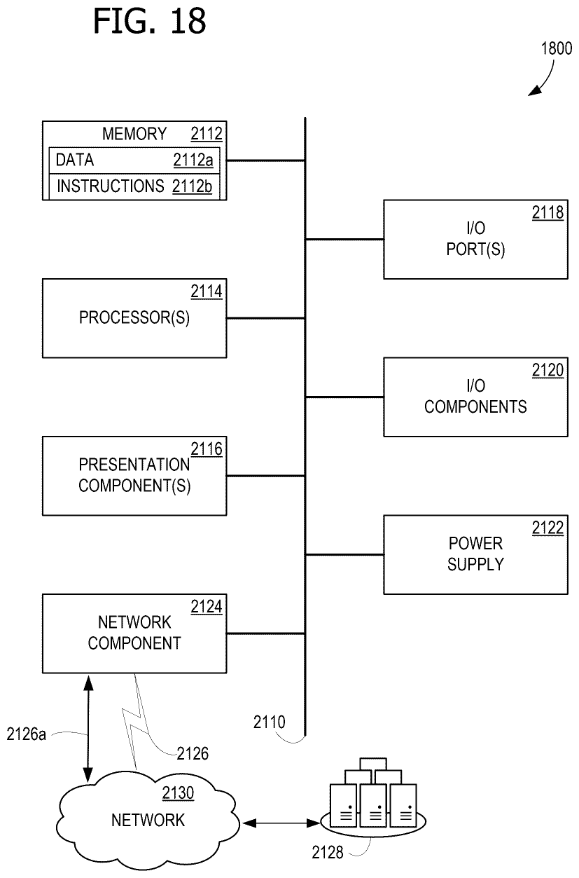

FIG. 18 is a block diagram of an example computing device 1800 (e.g., a computer storage device) for implementing aspects disclosed herein, and is designated generally as computing device 1800. In some examples, one or more computing devices 1800 are provided for an on-premises computing solution. In some examples, one or more computing devices 1800 are provided as a cloud computing solution. In some examples, a combination of on-premises and cloud computing solutions are used. Computing device 1800 is but one example of a suitable computing environment that can be used in the described system and is not intended to suggest any limitation as to the scope of use or functionality of the examples disclosed herein, whether used singly or as part of a larger set. Neither should computing device 1800 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1800 includes a bus 1810 that directly or indirectly couples the following devices: computer storage memory 1812, one or more processors 1814, one or more presentation components 1816, input/output (I/O) ports 1818, I/O components 1820, a power supply 1822, and a network component 1824. While computing device 1800 is depicted as a seemingly single device, multiple computing devices 1800 may work together and share the depicted device resources. For example, memory 1812 may be distributed across multiple devices, and processor(s) 1814 may be housed with different devices.

Bus 1810 represents what may be one or more busses (such as an address bus, data bus, or a combination thereof). Although the various blocks of FIG. 18 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 18 and the references herein to a “computing device.” Memory 1812 may take the form of the computer storage media referenced below and operatively provide storage of computer-readable instructions, data structures, program modules and other data for the computing device 1800. In some examples, memory 1812 stores one or more of an operating system, a universal application platform, or other program modules and program data. Memory 1812 is thus able to store and access data 1812a and instructions 1812b that are executable by processor 1814 and configured to carry out the various operations disclosed herein.

In some examples, memory 1812 includes computer storage media. Memory 1812 may include any quantity of memory associated with or accessible by the computing device 1800. Memory 1812 may be internal to the computing device 1800 (as shown in FIG. 18), external to the computing device 1800 (not shown), or both (not shown). Additionally, or alternatively, the memory 1812 may be distributed across multiple computing devices 1800, for example, in a virtualized environment in which instruction processing is carried out on multiple computing devices 1800. For the purposes of this disclosure, “computer storage media,” “computer-storage memory,” “memory,” and “memory devices” are synonymous terms for the computer-storage memory 1812, and none of these terms include carrier waves or propagating signaling.

Processor(s) 1814 may include any quantity of processing units that read data from various entities, such as memory 1812 or I/O components 1820. Specifically, processor(s) 1814 are programmed to execute computer-executable instructions for implementing aspects of the disclosure. The instructions may be performed by the processor, by multiple processors within the computing device 1800, or by a processor external to the client computing device 1800. In some examples, the processor(s) 1814 are programmed to execute instructions such as those illustrated in the flow charts discussed below and depicted in the accompanying drawings. Moreover, in some examples, the processor(s) 1814 represents an implementation of analog techniques to perform the operations described herein. For example, the operations may be performed by an analog client computing device 1800 and/or a digital client computing device 1800. Presentation component(s) 1816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1800, across a wired connection, or in other ways. I/O ports 1818 allow computing device 1800 to be logically coupled to other devices including I/O components 1820, some of which may be built in. Example I/O components 1820 include, for example but without limitation, a microphone, joystick, game pad, satellite dish, scanner, printer, wireless device, etc.

Computing device 1800 may operate in a networked environment via the network component 1824 using logical connections to one or more remote computers. In some examples, the network component 1824 includes a network interface card and/or computer-executable instructions (e.g., a driver) for operating the network interface card. Communication between the computing device 1800 and other devices may occur using any protocol or mechanism over any wired or wireless connection. In some examples, network component 1824 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1824 communicates over wireless communication link 1826 and/or a wired communication link 1826a to a remote resource 1828 (e.g., a cloud resource) across network 1830. Various different examples of communication links 1826 and 1826a include a wireless connection, a wired connection, and/or a dedicated link, and in some examples, at least a portion is routed through the internet.

Although described in connection with an example computing device 1800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method for fine-tuning a language model, the method comprising:
generating a dataset that includes a plurality of paired samples, each paired sample of the plurality of paired samples includes (i) a factual question and a true outcome for that factual question and (ii) a counterfactual question and a true outcome for that counterfactual question;
submitting a factual query to an answer model, the factual query including the factual question and the true outcome of the factual question;
receiving a factual answer from the answer model in response to the factual query;
submitting a counterfactual query to the answer model, the counterfactual query including the counterfactual question and the true outcome of the counterfactual question;
receiving a counterfactual answer from the answer model in response to the counterfactual query; and
performing fine-tuning on a target model using at least the factual question paired with the factual answer and the counterfactual question paired with the counterfactual answer.

2. The computerized method of claim 1, further comprising:
submitting a cybersecurity query to the target model, the cybersecurity query including a security log from a computing device and a prompt instructing analysis of the security log to identify suspicious activity, thereby causing the target model to generate an output identifying at least one anomalous event from the security log.

3. The computerized method of claim 1, wherein performing fine-tuning on the target model further includes performing supervised fine-tuning on the target model, wherein the factual question and the factual answer represent a first input-output pair and the counterfactual question and the counterfactual answer represent a second input-output pair.

4. The computerized method of claim 1, further comprising:
generating the factual query by concatenating the factual question with the true outcome of the factual question, thereby causing the true outcome of the factual question to appear at the end of the factual query; and
generating the counterfactual query by concatenating the counterfactual question with the true outcome of the counterfactual question, thereby causing the true outcome of the counterfactual question to appear at the end of the counterfactual query.

5. The computerized method of claim 1, wherein the factual answer includes the true outcome of the factual question, wherein the counterfactual answer includes the true outcome of the counterfactual question.

6. The computerized method of claim 1, wherein the counterfactual question is a reformulation of the factual question where a premise and assumption included in the factual question are altered in the counterfactual question such as to contradict the factual question.

7. The computerized method of claim 1, further comprising:
generating the factual question using a factual question template and inserting a first parameter into the factual question template; and
generating the counterfactual question using a counterfactual question template and inserting said first parameter into the counterfactual question template.

8. A system for fine-tuning generative artificial intelligence (GAI) models, the system comprising:
a processor; and
a memory comprising computer-readable instructions, the processor, the memory and the computer-readable instructions configured to cause the processor to:
generate a dataset that includes a plurality of paired samples, each paired sample of the plurality of paired samples includes (i) a factual question and a true outcome for that factual question and (ii) a counterfactual question and a true outcome for that counterfactual question;
submit a factual query to an answer model, the factual query including the factual question and the true outcome of the factual question, thereby causing the answer model to generate a factual answer in response to the factual query;
submit a counterfactual query to the answer model, the counterfactual query including the counterfactual question and the true outcome of the counterfactual question, thereby causing the answer model to generate a counterfactual answer in response to the counterfactual query; and
perform fine-tuning on a target model using at least the factual question paired with the factual answer and the counterfactual query paired with the counterfactual answer.

9. The system of claim 8, wherein performing fine-tuning on the target model further includes performing supervised fine-tuning on the target model, wherein the factual question and the factual answer represent a first input-output pair and the counterfactual question and the counterfactual answer represent a second input-output pair.

10. The system of claim 8, wherein the processor, the memory and the computer-readable instructions are further configured to cause the processor to:
generate the factual query by concatenating the factual question with the true outcome of the factual question, thereby causing the true outcome of the factual question to appear at the end of the factual query; and
generate the counterfactual query by concatenating the counterfactual question with the true outcome of the counterfactual question, thereby causing the true outcome of the counterfactual question to appear at the end of the counterfactual query.

11. The system of claim 8, wherein the factual answer includes the true outcome of the factual question, wherein the counterfactual answer includes the true outcome of the counterfactual question.

12. The system of claim 8, wherein the counterfactual question is a reformulation of the factual question where a premise and assumption included in the factual question are altered in the counterfactual question such as to contradict the factual question.

13. The system of claim 8, wherein the processor, the memory and the computer-readable instructions are further configured to cause the processor to:
generate the factual question using a factual question template and inserting a first parameter into the factual question template; and
generate the counterfactual question using a counterfactual question template and inserting said first parameter into the counterfactual question template.

14. The system of claim 8, wherein the answer model is a language model configured to generate outputs in a natural language, wherein the factual answer and the counterfactual answer are in the natural language, wherein the factual answer begins with the true outcome of the factual question, wherein the counterfactual answer begins with the true outcome of the counterfactual question.

15. A computer storage medium having computer-executable instructions that, upon execution by a processor of a computer, cause the processor to at least:
generate a dataset that includes a plurality of paired samples, each paired sample of the plurality of paired samples includes a factual question and a counterfactual question;
submit a plurality of factual queries to a target model, each factual query of the plurality of factual queries including the factual question and a different sampling temperature, thereby causing the target model to vary randomness of output;
receiving a plurality of factual answers from the target model in response to the submission of the plurality of factual queries;
submit a plurality of counterfactual queries to the answer model, each counterfactual query of the plurality of counterfactual queries including the counterfactual question and a different sampling temperature, thereby causing the target model to vary randomness of output;
receive a plurality of counterfactual answers from the target model in response to the submission of the plurality of counterfactual queries;
identify a preferred factual answer from the plurality of factual answers, the remaining factual answers of the plurality of factual answers being a disfavored factual answer;
identify a preferred counterfactual answer from the plurality of counterfactual answers, the remaining counterfactual answers of the plurality of counterfactual answers being a disfavored counterfactual answer; and
perform fine-tuning on the target model using at least (i) the factual question paired with the preferred factual answer and the disfavored factual answer and (ii) the counterfactual question paired with the preferred counterfactual answer and the disfavored counterfactual answer.

16. The computer storage medium of claim 15, wherein performing fine-tuning on the target model further includes performing preference-based fine-tuning on the target model using Direct Policy Optimization.

17. The computer storage medium of claim 16, wherein the instructions further cause the processor to:
identify a first triplet that includes the factual question, a first preferred factual answer, a first disfavored factual answer, and first preference data representing preference for the first preferred factual answer over the first disfavored factual answer;
identify a second triplet that includes the counterfactual question, a first preferred counterfactual answer, a first disfavored counterfactual answer, and second preference data representing preference for the first preferred counterfactual answer over the first disfavored counterfactual answer; and
fine-tune the target model via preference-based fine-tuning using at least the first triplet and the second triplet.

18. The computer storage medium of claim 15, wherein the counterfactual question is a reformulation of the factual question where a premise and assumption included in the factual question are altered in the counterfactual question such as to contradict the factual question.

19. The computer storage medium of claim 15, wherein the instructions further cause the processor to:
generate the factual question using a factual question template and inserting a first parameter into the factual question template; and
generate the counterfactual question using a counterfactual question template and inserting said first parameter into the counterfactual question template.

20. The computer storage medium of claim 15, wherein the instructions further cause the processor to:
submit a cybersecurity query to the target model, the cybersecurity query including a security log from a computing device and a prompt instructing analysis of the security log to identify suspicious activity, causing the target model to generate an output identifying at least one anomalous event from the security log.
